(19) United States
(12) Patent Application Publication
(10) Pub. No.: US 2016/0064994 A1
(43) Pub. Date: Mar. 3, 2016

(54) METHOD OF CONTROLLING WIRELESS POWER TRANSMISSION SYSTEM, WIRELESS POWER RECEIVING APPARATUS AND METHOD OF TRANSMITTING WIRELESS POWER

(71) Applicants: Hyundai Motor Company, Seoul (KR); Konkuk University Industrial Cooperation Corp, Seoul (KR)

(72) Inventors: Hyun Chul Ku, Seoul (KR); Jae Yong Seong, Anyang (KR); Won Shil Kang, Seoul (KR); Jong Gyun Lim, Seoul (KR)

(21) Appl. No.: 14/837,047

(22) Filed: Aug. 27, 2015

(30) Foreign Application Priority Data
Aug. 28, 2014 (KR) 10-2014-0113254

(51) Int. Cl. H02J 7/02; H02J 17/00

(52) U.S. Cl. CPC H02J 7/025; H02J 17/00

(57) ABSTRACT

Provided are a method of controlling a wireless power transmission system capable of controlling the wireless power transmission system in a wireless power receiving apparatus, a wireless power receiving apparatus, and a method of transmitting wireless power. The method of controlling the wireless power transmission system, which is performed on the wireless power receiving apparatus in a vehicle, includes receiving a plurality of transmission signals output from a plurality of transmission coils connected to a wireless power transmission apparatus in a charging station, in a receiving coil mounted on the vehicle, extracting power transmission efficiency for the plurality of transmission signals based on a power transmission parameter by the plurality of transmission signals, and transmitting transmission coil operation control information based on the power transmission parameter or the power transmission efficiency to the wireless power transmission apparatus.

### CLAIM FOR PRIORITY

This application claims priority to Korean Patent Application No. 2014-0113254 filed on Aug. 28, 2014 in the Korean Intellectual Property Office (KIPO), the entire contents of which are hereby incorporated by reference.

### BACKGROUND

1. Technical Field

Example embodiments of the present invention relate to a wireless power transmission system, and more specifically, to a method of controlling a wireless power transmission system capable of controlling the wireless power transmission system in a wireless power receiving apparatus, a wireless power receiving apparatus, and a method of transmitting wireless power.

2. Related Art

Wireless charging of an electric vehicle, which is belonging to the field of high power wireless power transmission which transmits power having a predetermined output (e.g., 2.4 kW) or more, may be divided into a magnetic induction method and a magnetic resonance method. The wireless power transmission technique expands to a structure associated with almost all field from a hardware structure of an assembly mounted on the vehicle to communications between the vehicles, between the vehicle and infrastructure (including wireless charging infrastructure), or between the vehicle and an object (including user terminal) through a fusion with other techniques such as wireless communication, personal information security, or the like in order to improve reliability, stability, durability, convenience, efficiency, functionality (payment service, etc.), or the like of a wireless charging system.

The magnetic induction type can wirelessly transmit power with relatively high efficiency within a short distance of about several centimeters. The magnetic resonance type has been studied and developed such that, for example, when a vehicle approaches a wireless charger, a wireless charging control apparatus of the vehicle recognizes the wireless charger and charges a battery through communication with the wireless charger.

The magnetic resonance is a highly efficient method for wireless power transmission and can transmit power to range from several centimeters to several meters, which is substantial compared to magnetic induction. However surrounding obstacles, metal materials, or debris may change a magnetic resonance characteristic, and thus power transmission efficiency decreases rapidly. Consequently, it is required to additionally control factors including frequency, coupling coefficient, and the like.

Additionally, since magnetic resonance has different operating methods for high power transmission and high efficiency, multiple transmitting sets may be required to satisfy the output power level that a receiver requests. In other words, when a transmitter-receiver block cannot transmit enough power requested by the receiver, multiple transmitting sets may be required. However, there are some cases where using multiple transmitting sets causes a decrease in efficiency, therefore a method for improving efficiency is necessary.

Further, in the wireless charging of the electric vehicle, in order to improve charging efficiency, it is necessary to arrange a primary coil and a secondary coil at a predetermined level or more, or appropriately control electromagnetic coupling between the primary coil and the secondary coil. Although studies related to the arrangement and/or the control have been conducted, a study in which the wireless power transmission is efficiently performed by controlling a plurality of transmission coils by the receiving apparatus is still scarce.

### SUMMARY

Accordingly, example embodiments of the present invention are provided to substantially obviate one or more problems due to limitations and disadvantages of the related art.

Example embodiments of the present invention provide a method of controlling a wireless power transmission system for effectively controlling transmission signals output from a plurality of transmission coils in a receiving apparatus of the wireless power transmission system.

Example embodiments of the present invention also provide a wireless power receiving apparatus for effectively controlling transmission signals output from a plurality of transmission coils.

Example embodiments of the present invention also provide a method of transmitting wireless power for outputting a plurality of transmission signals according to a control of a wireless power receiving apparatus.

In some example embodiments, a controlling method of a power transmission system according to an exemplary embodiment of the present invention may include matching phases and amplitudes of multiple transmission signals to be output respectively from multiple transmitter coils; separating the multiple transmission signals of which phases and amplitudes have been matched, and transmitting the separated transmission signals to a receiver coil; receiving the transmission signals and measuring power transmission efficiency; and adjusting phases and amplitudes of the multiple transmission signals based on the measured power transmission efficiency.

Here, the process of matching phases and amplitudes may include setting a transmission signal of one transmitter coil among the multiple transmitter coils to a reference signal. In addition, the process of matching phases and amplitudes may include extracting a phase difference between transmission signals by calculating a cross-correlation between the reference signal and transmission signals from the other transmitter coils. The process of matching phases and amplitudes may further include matching phases of the transmission signals by adjusting the extracted phase difference.

Here, the process of matching phases and amplitudes may include transmitting transmission signals from multiple transmitter coils to a receiver coil using carrier signals that have different frequencies. The carrier signals may be removed from the signals that have been transmitted to the receiver coil, and a phase difference may be extracted between the transmission signals. In addition, the phases of the transmission signals may be matched by adjusting the extracted phase difference.

Here, the process of measuring power transmission efficiency may include measuring power transmission efficiency with increasing or decreasing amplitude and phase of a transmission signal from a respective transmitter coil. The process of adjusting phase and amplitude of the multiple transmission signals may include setting phase and amplitude to those in which the measured power transmission efficiency is a highest. The controlling method of a power transmission system may further include storing the adjusted phase and amplitude and a vehicle identification number that corresponds to the phase and amplitude.

Here, a vehicle identification number may be detected, and when the identification number is a stored number, phase and amplitude of the multiple transmission signals may be adjusted to be a phase and amplitude that correspond to the vehicle identification number. The controlling method of a power transmission system may further include observing vehicle surroundings using capturing devices (e.g., imaging devices, sensors, or the like) in a front part and an upper part of the vehicle before transmitting the transmission signals to a receiver coil.

Here, a controlling method of a power transmission system according to an exemplary embodiment of the present invention may thus control phase and amplitude of a respective transmission signal by synchronizing transmission signals output from multiple transmitters. The method may also increase power transmission efficiency by adjusting amplitude and phase of each of the multiple transmission signals. The method may also improve safety in the process of power transmission.

In other example embodiments, a method of controlling a wireless power transmission system, which is performed on a wireless power receiving apparatus in a vehicle, includes receiving a plurality of transmission signals output from a plurality of transmission coils connected to a wireless power transmission apparatus in a charging station, in a receiving coil mounted on the vehicle, extracting power transmission efficiency for the plurality of transmission signals based on a power transmission parameter by the plurality of transmission signals, and transmitting transmission coil operation control information based on the power transmission parameter or the power transmission efficiency to the wireless power transmission apparatus.

Here, the method of controlling the wireless power transmission system may further include, before the receiving of the plurality of transmission signals, obtaining control authority for at least some operations of the wireless power transmission apparatus.

Here, the method of controlling the wireless power transmission system may further include, before the extracting of the power transmission efficiency, transmitting a signal for adjusting a position of the receiving coil and at least any one of positions of the plurality of transmission coils to the wireless power transmission apparatus.

Here, the method of controlling the wireless power transmission system may further include, before the receiving of the plurality of transmission signals, transmitting a signal for controlling outputs of the plurality of transmission signals to the size of 50% or less of rated output power in the plurality of transmission coils to the wireless power transmission apparatus.

Here, the transmitting of the transmission coil operation control information may include changing a phase of a transmission signal of at least any one of the plurality of transmission coils through the transmission coil operation control information.

Here, the method of controlling the wireless power transmission system may further include, after the transmitting of the transmission coil operation control information, receiving the plurality of transmission signals with the same phase.

Here, the method of controlling the wireless power transmission system may further include, after the transmitting of the transmission coil operation control information, extracting correlation between the plurality of transmission signals representing maximum power transmission efficiency based on a change of the power transmission efficiency, and transmitting wireless power transmission control information based on the correlation to the wireless power transmission apparatus.

In still other example embodiments, a wireless power receiving apparatus includes a receiving unit which receives a plurality of transmission signals output from a plurality of transmission coils connected to a wireless power transmission apparatus in a charging station, in a receiving coil, an extraction unit which extracts power transmission efficiency for the plurality of transmission signals based on a power transmission parameter by the plurality of transmission signals, and a transmission unit which transmits transmission coil operation control information based on the power transmission parameter or the power transmission efficiency to the wireless power transmission apparatus.

Here, the wireless power receiving apparatus may further include an authentication unit which obtains control authority for at least some operations of the wireless power transmission apparatus.

Here, the wireless power receiving apparatus may further include a position adjustment unit which transmits a signal for adjusting a position of the receiving coil and at least any one of positions of the plurality of transmission coils according to the power transmission parameter or the power transmission efficiency to the wireless power transmission apparatus.

Here, the wireless power receiving apparatus may further include an initial setting unit which transmits a signal for controlling outputs of the plurality of transmission signals to the size of 50% or less of rated output power in the plurality of transmission coils to the wireless power transmission apparatus.

Here, the wireless power receiving apparatus may further include a phase adjustment unit which changes a phase of a transmission signal of at least any one of the plurality of transmission coils through the transmission coil operation control information.

Here, the receiving unit may receive the plurality of transmission signals with the same phase.

Here, the extraction unit may extract correlation between the plurality of transmission signals having maximum power transmission efficiency based on the plurality of transmission signals with the same phase or a change of the power transmission efficiency. The transmission unit may transmit wireless power transmission control information based on the correlation to the wireless power transmission apparatus.

Here, the wireless power receiving apparatus may further include a charging unit which receives wireless power according to the wireless power transmission control information and charges a battery.

In still other example embodiments, a method of transmitting wireless power includes outputting a plurality of transmission signals from a plurality of transmission coils, receiving transmission coil operation control information including a power transmission parameter by the plurality of transmission signals received in a receiving coil or power transmission efficiency corresponding to the power transmission parameter in a vehicle, from a wireless power receiving apparatus in the vehicle, and adjusting outputs of the plurality of transmission signals based on the transmission coil operation control information.

Here, the method of transmitting wireless power may further include, before the outputting of the plurality of transmission signals, generating the plurality of transmission signals having the size of 50% or less of rated output power in the plurality of transmission coils according to a transmission signal output request received from the wireless power receiving apparatus.

Here, the method of transmitting wireless power may further include, before the receiving of the transmission coil operation control information, receiving a position adjustment request signal for adjusting positions of the plurality of transmission coils or a position of a transmission pad including the plurality of transmission coils based on the power transmission parameter or the power transmission efficiency, and adjusting the positions of the plurality of transmission coils or the position of the transmission pad in response to the position adjustment request signal.

Here, the method of transmitting wireless power may further include adjusting an output or phase of at least one of the transmission signals according to the transmission coil operation control information and outputting the plurality of transmission signals of which the output or the phase is adjusted.

Here, the method of transmitting wireless power may further include receiving wireless power transmission control information based on correlation between the plurality of transmission signals from the wireless power receiving apparatus, and determining the outputs of the plurality of transmission signals according to the wireless power transmission control information and transmitting wireless power to the receiving coil.

### BRIEF DESCRIPTION OF DRAWINGS

Example embodiments of the present invention will become more apparent by describing in detail example embodiments of the present invention with reference to the accompanying drawings, in which:

FIG. 1 is a schematic diagram illustrating a wireless power transmission system according to an embodiment of the present invention;

FIG. 2 is a schematic flowchart for describing a method of controlling a wireless power transmission system according to an embodiment of the present invention;

FIG. 3 is a flowchart for describing an embodiment of a synchronization process and a size adjustment process of FIG. 2;

FIG. 4 is a flowchart for describing another embodiment of the synchronization process and the size adjustment process of FIG. 2;

FIG. 5 is a diagram illustrating an example of an arrangement relation between a plurality of transmission coils and a receiving coil according to an embodiment of the present invention;

FIG. 6 is a graph illustrating a relation between a phase difference of transmission signals transmitted from transmission coils and a power size and transmission efficiency in a receiving coil when the transmission coils and the receiving coil are disposed like in FIG. 5;

FIG. 7 is a diagram illustrating an example of phases and sizes of transmission signals as transmission signals that may be used in a wireless power transmission apparatus according to an embodiment of the present invention using a quadrature amplitude modulation (QAM) method;

FIG. 8 is a diagram for describing a process of changing a phase and size of a transmission signal in a method of controlling a wireless power transmission system according to an embodiment of the present invention;

FIG. 9 is a diagram illustrating an example of the number of vector axes according to a phase and a size compared to the number of transmission coils in a method of controlling a wireless power transmission system according to an embodiment of the present invention;

FIG. 10 is a flowchart for describing a method of controlling a wireless power transmission system according to another embodiment of the present invention;

FIG. 11 is a block diagram for describing a wireless power transmission apparatus according to another embodiment of the present invention;

FIG. 12 is a partial flowchart for describing some operating processes of the wireless power transmission apparatus of FIG. 11;

FIG. 13 is a diagram illustrating an example of a configuration that may be applied to a transmission circuit array of the wireless power transmission system of FIG. 1;

FIG. 14 is a schematic block diagram illustrating a wireless power receiving apparatus according to still another embodiment of the present invention;

FIG. 15 is a flowchart for describing a process of controlling a plurality of transmission signals of a wireless power transmission apparatus by the wireless power receiving apparatus of FIG. 14;

FIG. 16 is a partial block diagram illustrating a wireless power receiving apparatus according to still another embodiment of the present invention;

FIGS. 17 to 10 are flowcharts for describing a process of adjusting outputs of a plurality of transmission signals of a wireless power transmission apparatus by the wireless power receiving apparatus of FIG. 16; and

FIGS. 20A-20E are diagrams illustrating an example of a pad structure that may be applied to a transmission pad or a receiving pad of the wireless power transmission system according to the embodiments of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein. While describing the respective drawings, like reference numerals designate like elements.

It will be understood that although the terms “first”, “second”, etc. may be used herein to describe various components, these components should not be limited by these terms. These terms are used merely to distinguish one element from another. For example, without departing from the scope of the present invention, a first component may be designated as a second component, and similarly, the second component may be designated as the first component. The term “and/or” include any and all combinations of one of the associated listed items.

It will be understood that when a component is referred to as being “connected to” another component, it can be directly or indirectly connected to the other component. That is, for example, intervening components may be present. On the contrary, when a component is referred to as being “directly connected to” another component, it will be understood that there is no intervening components.

Terms are used herein only to describe the exemplary embodiments but not to limit the present invention. Singular expressions, unless defined otherwise in contexts, include plural expressions. In the present specification, terms of “comprise” or “have” are used to designate features, numbers, steps, operations, elements, components or combinations thereof disclosed in the specification as being present but not to exclude possibility of the existence or the addition of one or more other features, numbers, steps, operations, elements, components, or combinations thereof.

All terms including technical or scientific terms, unless being defined otherwise, have the same meaning generally understood by a person of ordinary skill in the art. It will be understood that terms defined in dictionaries generally used are interpreted as including meanings identical to contextual meanings of the related art, unless definitely defined otherwise in the present specification, are not interpreted as being ideal or excessively formal meanings.

Hereinafter, example embodiments of the present invention will be described in detail with reference to the attached drawings.

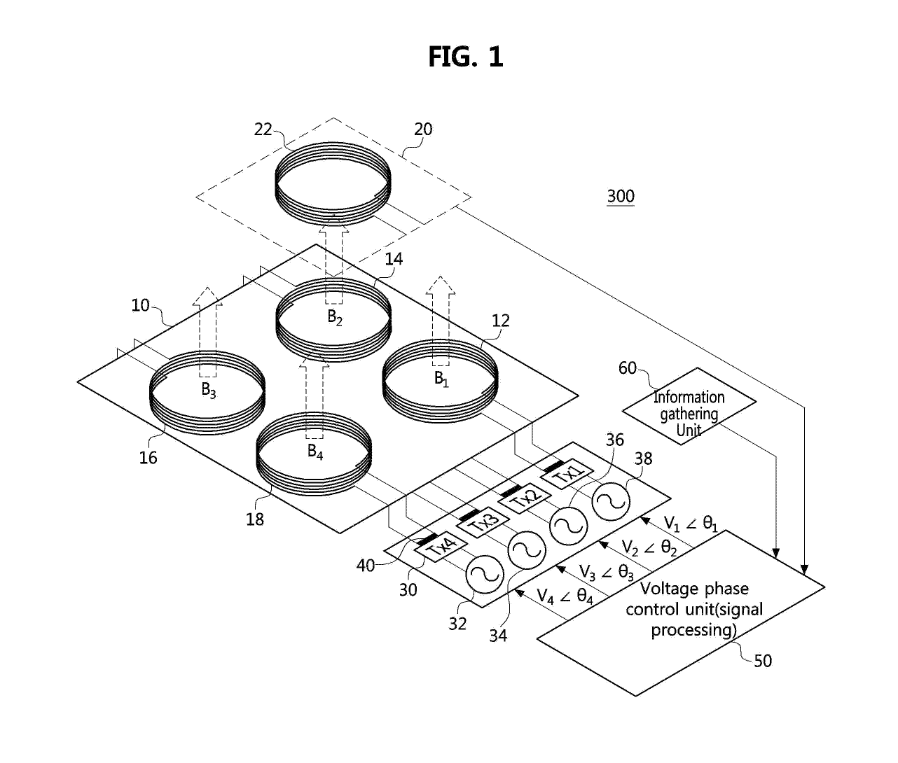

FIG. 1 is a schematic diagram illustrating a wireless power transmission system according to an embodiment of the present invention.

Referring to FIG. 1, a wireless power transmission system 300 according to the present embodiment may include a transmission pad 10 including a plurality of transmission coils 12, 14, 16, and 18, a receiving coil 22, a receiving pad 20, transmission circuits which control transmission signals output from the transmission coils 12, 14, 16, and 18, charging power supplies 32, 34, 36, and 38 which are connected to the transmission circuits and supply power (charging power source) to the transmission coils 12, 14, 16, and 18, a transmission circuit array 30 including the transmission circuits and the charging power supplies, a controller 50 which controls a size and phase of power supplied from the charging power supplies 32, 34, 36, and 38 to each transmission circuit and receives voltage/current waveform and power information from a receiving apparatus including the receiving coil 22 or a sensor 40 coupled to the transmission circuits, and a data collector 60 which transmits identification (ID) information of a vehicle and information in vicinity of the vehicle to the controller 50. Hereinafter, the controller 50 may be referred to as a voltage phase control unit, a signal processing unit or a control unit. Also, the data collector 60 may be corresponded to an information gathering unit or an information collection unit.

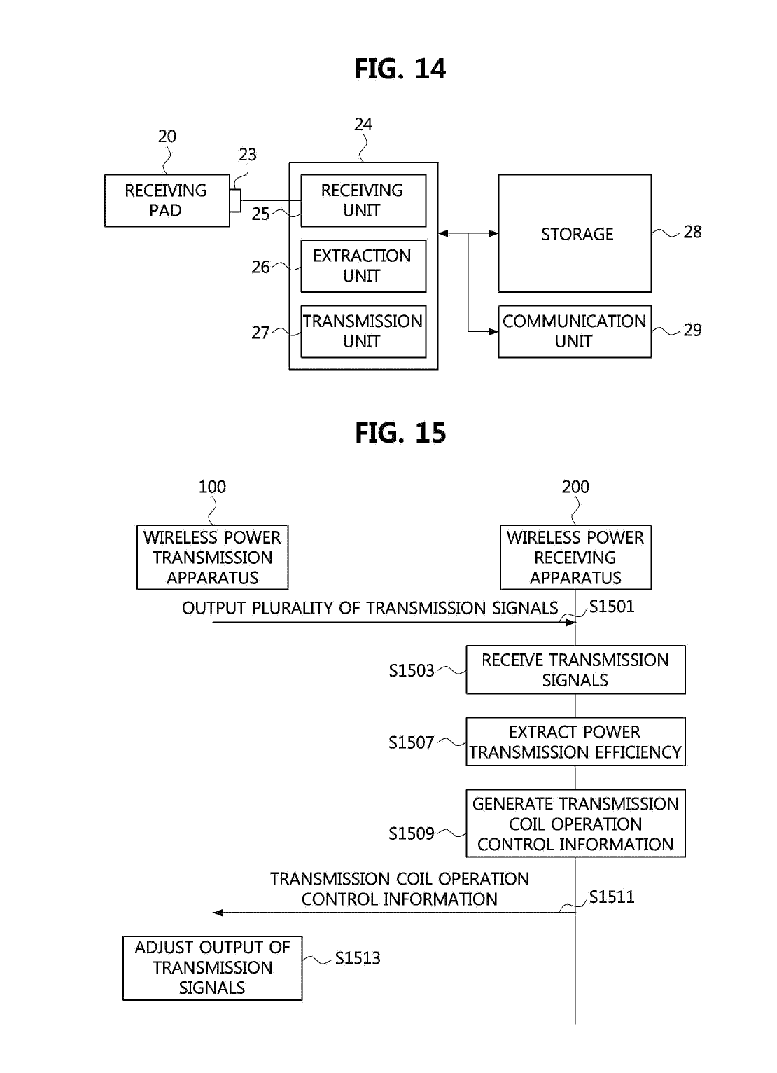

The wireless power transmission system 300 according to the present embodiment may include a wireless power transmission apparatus and a wireless power receiving apparatus. In this case, the wireless power transmission apparatus may include the plurality of transmission coils 12, 14, 16, and 18, the transmission pad 10, a plurality of transmission circuits Tx1, Tx2, Tx3, and Tx4 connected to the plurality of transmission coils, respectively, the plurality of charging power supplies 32, 34, 36, and 38 which each supply power to the plurality of transmission circuits, the transmission circuit array 30 in which the plurality of transmission circuits and the plurality of charging power supplies are arranged, and the controller 50 which controls the plurality of transmission circuits and the plurality of charging power supplies. Also, the wireless power receiving apparatus may include the receiving coil 22, the receiving pad 20, a controller 24 (see FIG. 14) connected to the receiving coil or the receiving pad, and a communication unit 29 (see FIG. 14) which communicates with the wireless power transmission apparatus.

The wireless power transmission apparatus may control a plurality of transmission signals output from the plurality of transmission coils by the plurality of transmission coils 12, 14, 16, and 18 and the plurality of transmission circuits Tx1, Tx2, Tx3, and Tx4 connected to the plurality of transmission coils, respectively, which are disposed in an array form or a grid form on the same plane. Specifically, the wireless power transmission apparatus according to the present embodiment may be implemented to have optimal power transmission efficiency and transmit wireless power by a control of the wireless power receiving apparatus in at least some operations.

Further, the wireless power transmission apparatus may further include the sensor 40 which is coupled to the plurality of transmission circuits Tx1 to Tx4 or the plurality of transmission coils 12, 14, 16, and 18, detects a power transmission parameter by the transmission signals, and transmits the detected power transmission parameter to the controller 50. In the present embodiment, the wireless power transmission apparatus may share the power transmission parameter detected by the sensor 40 with the wireless power receiving apparatus.

Components of the wireless power receiving apparatus and the wireless power transmission apparatus and a combination relation therebetween will be described in detail below.

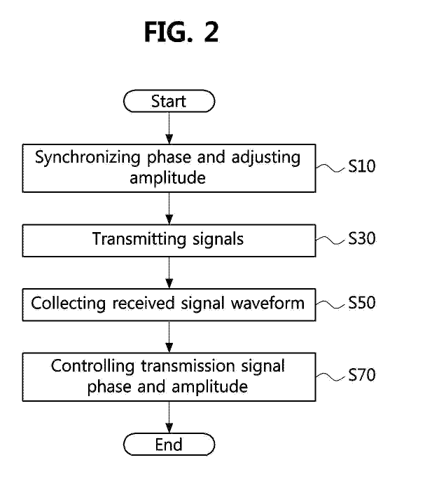

FIG. 2 is a schematic flowchart for describing a method of controlling a wireless power transmission system according to an embodiment of the present invention.

The method of controlling the wireless power transmission system according to the embodiment may be performed on the wireless power transmission system in FIG. 1 by the wireless power receiving apparatus. The wireless power receiving apparatus may be referred to as a control apparatus connected to the receiving coil and the receiving pad, or an apparatus including all the receiving coil, the receiving pad, and the control apparatus. The control apparatus may correspond to a vehicle controller and a wireless charging control apparatus of the vehicle, but is not limited thereto.

Referring to FIG. 2, in the method of controlling the wireless power transmission system according to the embodiment, first, the wireless power transmission apparatus may synchronize phases of the transmission signals of the plurality of transmission coils and uniformly adjust sizes or amplitudes thereof according to an output request for the plurality of transmission signals by the wireless power receiving apparatus (S10).

The operation (S10) may include uniformly setting all the phases of the plurality of transmission signals to a predetermined phase (e.g., phase of 0), setting all the sizes of the transmission signals to a predetermined size (e.g., 50%) smaller than a preset size of any one transmission signal among the plurality of transmission signals, or setting all the transmission signals to have the phase of 0 and the size of 50% or less of rated output power of the plurality of transmission signals, based on a specific time before wireless power transmission to the receiving coil is started.

In Operation S10, the synchronization of the phases of the plurality of transmission signals and the uniformly setting of the sizes may be effective to control an output of each of the plurality of transmission signals in the subsequent process so as to obtain maximum power transmission efficiency for the wireless power transmission.

Next, the wireless power transmission apparatus transmits the transmission signals having the uniform phases and sizes from the plurality of transmission coils to the receiving coil (S30). That is, the wireless power receiving apparatus receives the plurality of transmission signals. The plurality of transmission signals may be transmitted from each of the plurality of transmission coils to the receiving coil using an electromagnetic induction method or a magnetic resonance method. The number of the receiving coils may be one or may be smaller than the number of the transmission coils. When the plurality of receiving coils are arranged on the receiving pad, it may be implemented to use any one of the plurality of receiving coils until the wireless power transmission apparatus determines the outputs of the plurality of transmission signals to prepare the plurality of transmission coils.

Next, the power transmission parameter by the transmission signals transmitted between the plurality of transmission coils and the single receiving coil is collected (S50). The power transmission parameter may include any one signal waveform or power information of a voltage and current for each transmission coil or all the transmission coils. Further, the power transmission parameter may include any one waveform or power information of a voltage and current induced to the receiving coil.

Next, the wireless power receiving apparatus controls the output of each of the plurality of transmission signals based on the power transmission parameter or the power transmission efficiency by the power transmission parameter (S70). The controlling of the output of each of the plurality of transmission signals may include adjusting the phase of each of the plurality of transmission signals. Further, the controlling of the output of each of the plurality of transmission signals may include adjusting the size or the amplitude of each of the plurality of transmission signals.

In Operation S70, the wireless power receiving apparatus controls so that the outputs of the plurality of transmission signals are adjusted according to the power transmission parameter by the plurality of transmission signals or the power transmission efficiency and the receiving coil receives the transmission signals having the maximum power transmission efficiency through a collaboration with the wireless power transmission apparatus. When the phase of each of the plurality of transmission signals is adjusted, the receiving coil may receive the plurality of transmission signals with the same phase.

More specifically, for example, the wireless power receiving apparatus may provide transmission coil operation control information to the wireless power transmission apparatus to control the phase and size of each of the plurality of transmission signals. In this case, as illustrated in FIG. 1, the controller 50 of the wireless power transmission apparatus may adjust the phase and size of each of the plurality of transmission signals so that the first transmission coil 12 arranged in a first area B1 of the transmission pad 10 transmits a first transmission signal, the second transmission coil 14 arranged in a second area B2 of the transmission pad 10 transmits a second transmission signal, the third transmission coil 16 arranged in a third area B3 of the transmission pad 10 transmits a third transmission signal, and the fourth transmission coil 18 arranged in a fourth area B4 of the transmission pad 10 transmits a fourth transmission signal. Here, the first transmission signal may be adjusted to have a first phase and a first size (V1<θ1), the second transmission signal may be adjusted to have a second phase and a second size (V2<θ2), the third transmission signal may be adjusted to have a third phase and a third size (V3<θ3), and the fourth transmission signal may be adjusted to have a fourth phase and a fourth size (V4<θ4).

Meanwhile, in the method of controlling the wireless power transmission system according to the present embodiment, the synchronization of the plurality of transmission signals and the adjusting of the size thereof (S10) (hereinafter, referred to as a first operation) are basically and simultaneously performed on the plurality of transmission coils, but are not limited thereto. For example, in the first operation, it may be implemented to generate the first transmission signal in at least one transmission coil of the plurality of transmission coils, and the second transmission signal in at least one of the other transmission coils of the plurality of transmission coils after a preset time passes. In this case, the wireless power receiving apparatus may extract the power transmission parameter in each or in a group of the plurality of transmission coils which sequentially output the plurality of transmission signals, or the power transmission efficiency based on the power transmission parameter, and may determine an arrangement relation between the plurality of transmission coils and the receiving coil based on a plurality of power transmission parameters or the power transmission efficiency. Of course, the determined arrangement relation between the coils may be used to move the transmission pad or the receiving pad for arranging the coils as required.

Further, the method of controlling the wireless power transmission system according to the present embodiment may further include changing the phase of at least one of the transmission signals of the plurality of transmission coils (referred to as an operation 1A) after the first operation. When the operation 1A is used, before the wireless power transmission operation, the power transmission parameter of the transmission signals or the power transmission efficiency transmitted to the receiving coil may be changed through a change of the preset transmission signals with the transmitting of the transmission signals having the same phase to the receiving coil in the plurality of transmission coils, and an optimized wireless power transmission environment may be effectively set in the wireless power receiving apparatus of the vehicle by adjusting positions of the coils according to the change of the power transmission parameter of the transmission signals or the power transmission efficiency on the receiving coil or by adjusting the individual output of the transmission signals.

Further, in the above-described collecting of the power transmission parameter (referred to as a third operation) (S50), when the phase of at least one of the transmission signals of the plurality of transmission coils is changed, the power transmission parameter according to the change of the phase of at least one transmission signal may be extracted or received. For example, the controller of the wireless power receiving apparatus may use the power transmission parameter for each transmission coil or a plurality of groups of the transmission coils and a maximum value, minimum value, or average of the power transmission parameters. And thus, when the output of each of the plurality of transmission coils based on the power transmission parameter is adjusted, control stability and/or reliability may be improved and preset reference efficiency (maximum power transmission efficiency or the like), a pattern, a wireless power transmission condition, or the like may be further effectively applied.

For example, in the above-described collecting of the power transmission parameter (S50), in some implementations, the phases of the first transmission signals for a first group of the transmission coils among the plurality of transmission coils may be changed and first power transmission parameters for the first transmission signals may be extracted, and the phase of the second transmission signal for a second group of the transmission coils among the plurality of transmission coils may be changed and second power transmission parameters for the second transmission signals may be extracted. In this case, the above-described adjusting of the output or phase of each of the plurality of transmission signals (S70) may be performed based on a greater value among first power transmission efficiency calculated by the first power transmission parameters and second power transmission efficiency calculated by the second power transmission parameters.

On the other hand, the above-described method of controlling the wireless power transmission system may further include receiving identification information on the receiving pad or the vehicle from the controller of the vehicle on which the wireless power receiving apparatus is mounted before the plurality of transmission signals are generated to have the same phases and sizes. In this case, in the method of controlling the wireless power transmission system, the plurality of transmission signals may be synchronized or the sizes thereof may be effectively adjusted using the identification information on the receiving pad or the vehicle in the first operation (S10). That is, the controller of the wireless power receiving apparatus may effectively adjust the outputs of the plurality of transmission signals using data such as a reference phase, a reference size, a previously used phase, a previously used size, or the like, which are stored in a storage unit or a lookup table corresponding to the identification information of the receiving pad or the identification information of the vehicle.

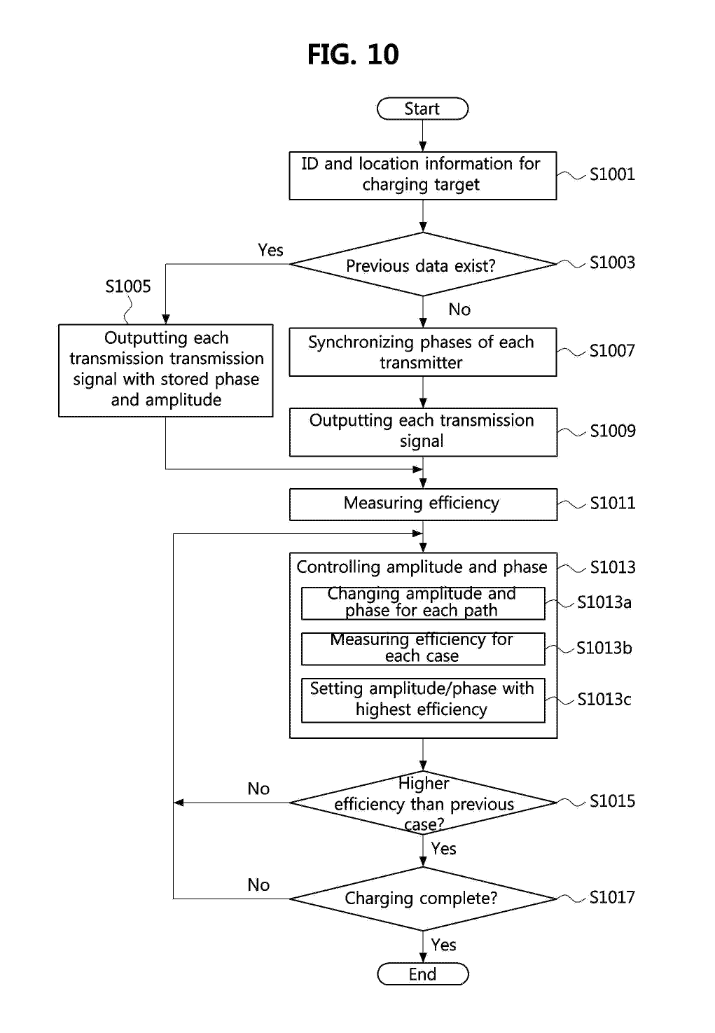

In this manner, in the method of controlling the wireless power transmission system according to the present embodiment, in an embodiment, phases and sizes of the plurality of transmission signals to be output from the plurality of transmission coils 12, 14, 16, and 18 may be matched (S10), the plurality of transmission signals of which the phases and sizes are matched may be individually transmitted to the receiving coil (S30), the power transmission parameter by the signals (transmission signals) transmitted to the receiving coil may be collected (S50), the power transmission efficiency may be measured (S1011) (see FIG. 10), and the phase and size of each of the plurality of transmission signals may be adjusted (S70) based on the measured power transmission efficiency or the power transmission parameter.

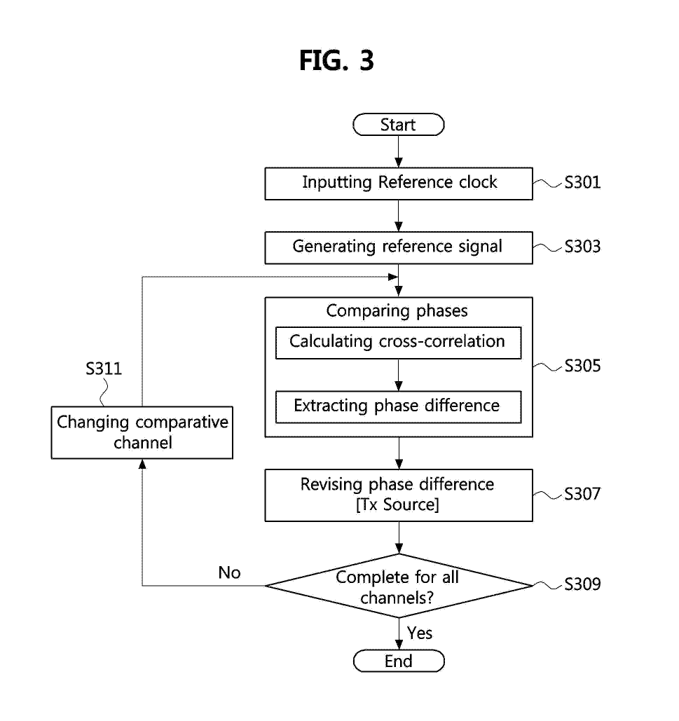

FIG. 3 is a flowchart for describing an embodiment of the synchronization process and the size adjustment process of FIG. 2.

Referring to FIG. 3, in the method of controlling the wireless power transmission system according to the present embodiment, the phases of the plurality of transmission signals may be matched in the synchronization process and the size adjustment process (S10) (see FIG. 2). To this end, the wireless power transmission apparatus may generate a transmission signal of any one transmission coil of the plurality of transmission coils 12, 14, 16, and 18 as a reference transmission signal in response to an input of a reference clock (S301 and S303).

A correlation between the generated reference transmission signal and the other transmission signals is calculated and a phase difference between the reference transmission signal and each transmission signal may be extracted (S305), and the phase difference of each transmission signal may be revised (S307). Also, whether the phase difference correction is completed or not for all channels of the transmission signals may be determined (S309). When it is determined that the phase difference correction is not completed, a comparative channel may be replaced (S311), and the phase comparison operation and the phase difference correction operation may be performed again by being fed back to the phase comparison operation (S305). On the other hand, when it is determined that the phase difference correction is completed for all the channels, the wireless power transmission apparatus may terminate the current process in which the phases of the transmission signals are matched according to a transmission signal output request of the wireless power receiving apparatus.

Meanwhile, in the present embodiment, when the plurality of transmission signals are output according to a request of the wireless power receiving apparatus, the wireless power transmission apparatus may initially set the sizes of the plurality of transmission signals. For example, the sizes of the plurality of transmission signals may be initially set to a predetermined ratio (e.g., 50%) or less of rated output power of the plurality of transmission signals. When the sizes of the plurality of transmission signals are initially set to the size of 50% or less, for example, 1/100 times or 1/10,000 times of the rated output power, the outputs of the plurality of transmission signals for the wireless power transmission by the wireless power receiving apparatus using the plurality of transmission signals having very small outputs may be determined.

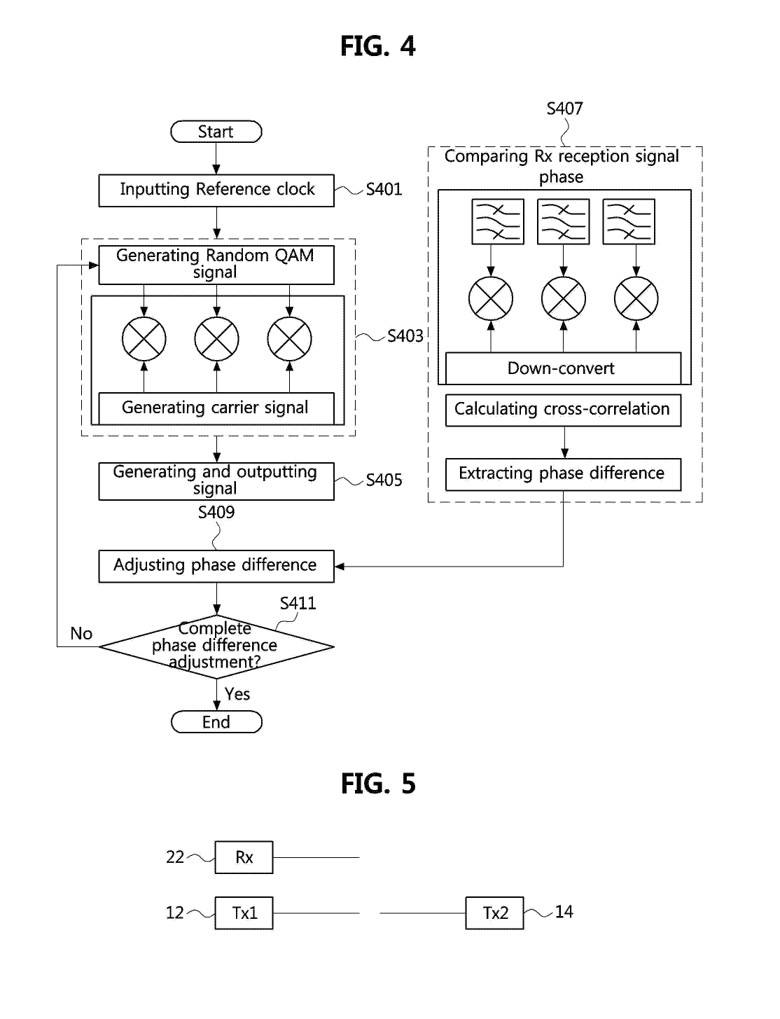

FIG. 4 is a flowchart for describing another embodiment of the synchronization process and the size adjustment process of FIG. 2.

Referring to FIGS. 1 and 4, in the method of controlling the wireless power transmission system according to the present embodiment, the phases of the plurality of transmission signals may be matched in the synchronization process and the size adjustment process (S10) (see FIG. 2). To this end, the wireless power transmission apparatus may generate transmission signals of the plurality of transmission coils 12, 14, 16, and 18 using a carrier signal having a different frequency according to a request of the wireless power receiving apparatus to output to the receiving coil 22 (S401, S403, and S405).

More specifically, first, the controller of the wireless power transmission apparatus is input a synchronization clock used for any one of the transmission signals of the plurality of transmission coils as a reference clock (S401).

Next, the controller generates the transmission signal of each transmission coil as a predetermined signal, for example, a quadrature amplitude modulation (QAM) signal, and the generated QAM signal is output from each transmission coil by loading on the separately prepared carrier signal (S403 and S405).

The transmission signals output from the transmission coils are each transmitted to the receiving coil and the phase therebetween is compared in the wireless power receiving apparatus (S407). That is, the wireless power receiving apparatus may set signals on paths from the transmission coils to the receiving coil to a predetermined frequency, separate a baseband signal from each path by performing a digital filtering, and then calculate a correlation between the baseband signals corresponding to the plurality of transmission signals. The digital filtering may include a down-convert process. Also, the wireless power receiving apparatus may transmit the correlation between the transmission signals to the controller 50 (see FIG. 1) of the wireless power transmission apparatus.

Next, the controller may correct the phase difference of the plurality of transmission signals based on the correlation received from the wireless power receiving apparatus (S409).

Next, the controller determines whether the phase difference correction is completed or not for all the transmission signals (S411). When it is determined that the phase difference correction is not completed, the subsequent operations may be repeatedly performed by being returned to the signal generation operation S403. On the other hand, when it is determined that the phase difference correction is completed in Operation S411, the current synchronization process and the size adjustment process may proceed to the transmitting of each transmission signal to the receiving coil (S30) (see FIG. 2).

According to the present embodiment, in the method of controlling the wireless power transmission system, the wireless power transmission apparatus may output the plurality of transmission signals from the plurality of transmission coils to the receiving coil with the same phase according to the request of the wireless power receiving apparatus. Thus, the adjustment or the output determination of the plurality of transmission signals may be easily performed on the subsequent control process.

Meanwhile, in the present embodiment or the other embodiments below, it is described that the QAM method is used when the transmission signal is modulated to a predetermined signal, but is not limited thereto. In some implementations, it may be implemented to convert the transmission signal into a modulated signal or a high frequency signal using an analog modulation such as an amplitude modulation, a frequency modulation, or a phase modulation, a digital modulation such as an amplitude shift keying (ASK), a frequency shift keying (FSK), a phase shift keying (PSK), a continuous phase modulation (CPM), a trellis coded modulation (TCM), or the like, or a pulse modulation such as a pulse code modulation (PCM), a pulse width modulation (PWM), a pulse amplitude modulation (PAM), a pulse position modulation (PPM), a pulse density modulation (PDM), or the like.

FIG. 5 is a diagram illustrating an example of an arrangement relation between a plurality of transmission coils and a receiving coil according to an embodiment of the present invention.

Referring to FIG. 5, the wireless power transmission apparatus according to the present embodiment may include a plurality of transmission coils arranged on the transmission pad in an array form or a grid form, and at least two transmission coils 12 and 14 of the plurality of transmission coils may be disposed on the same plane. The first transmission coil (Tx1) 12 and the second transmission coil (Tx2) 14 may be disposed on the same plane side by side at a predetermined interval.

Further, the wireless power receiving apparatus may include one receiving coil, and the one receiving coil (Rx) 22 may be arranged with any one of the two transmission coils 12 and 14, for example, the first transmission coil 12 at a predetermined interval in a vertical direction.

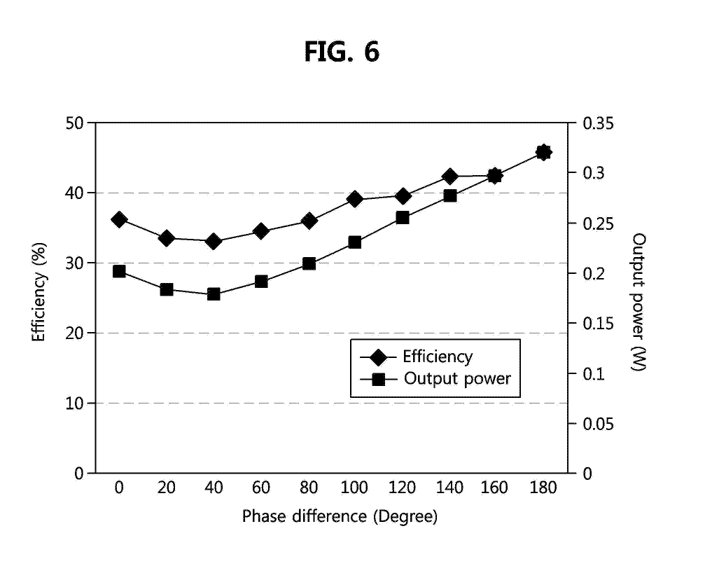

FIG. 6 is an exemplary graph of a phase difference of transmission signals from transmitter coils, output power on a receiver coil, and transmission efficiency in which the transmitter coils and receiver coil are disposed as FIG. 5.

Referring to FIGS. 5 and 6, under the assumption that center points of a receiver coil 22 and a first transmitter coil 12 are arranged on a perpendicular line, when the phase difference between the transmission signal from the first transmitter coil 12 and the transmission signal from the second transmitter coil 14 is about 180 degrees, the power transmission efficiency may have a maximum value and the output power may be at a highest.

This case is an example in which a transmitter coil of a transmitter pad 10 may be composed of the first transmitter coil 12 and the second transmitter coil 14. The power transmission efficiency on a receiver pad 20 may be different based on changes in phase and amplitude of the transmission signals. Additionally, according to the positions of the receiver coil 22 and transmitter coils 12, 14, 16, 18, the amplitude and phase difference of the transmission signals output from the transmitter coils 12, 14, 16, 18 may be varied to achieve a highest power transmission efficiency.

FIG. 7 is an exemplary showing phase and amplitude of transmission signals in quadrature amplitude modulation (QAM) mode.

As shown in FIG. 7, phase and amplitude of transmission signals traveling along respective paths from the transmitter coils to the receiver coil may be varied. The view in FIG. 7 is a QAM mode and is an example in which a most efficient amplitude and phase of the transmission signals for each path are described. To charge power from the transmitter coils for the first time, amplitudes and phases of the transmission signals from the respective transmitter coils may be matched for each path. For example, charging may be started in which amplitudes of the transmission signals have been matched to be about 50% of the maximum value and phases of those have been matched to be about 0 degrees.

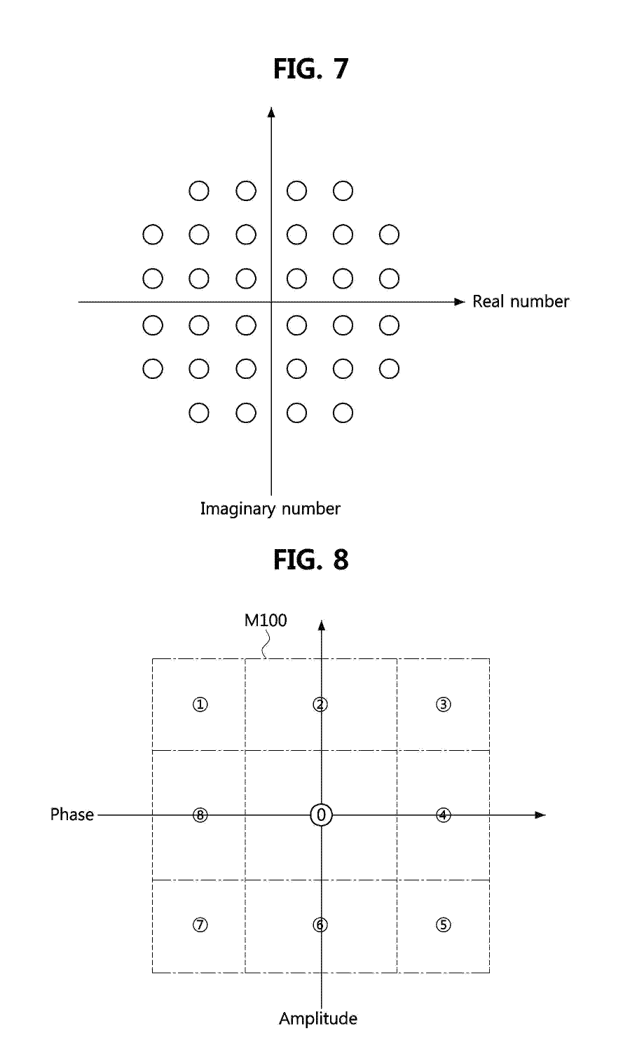

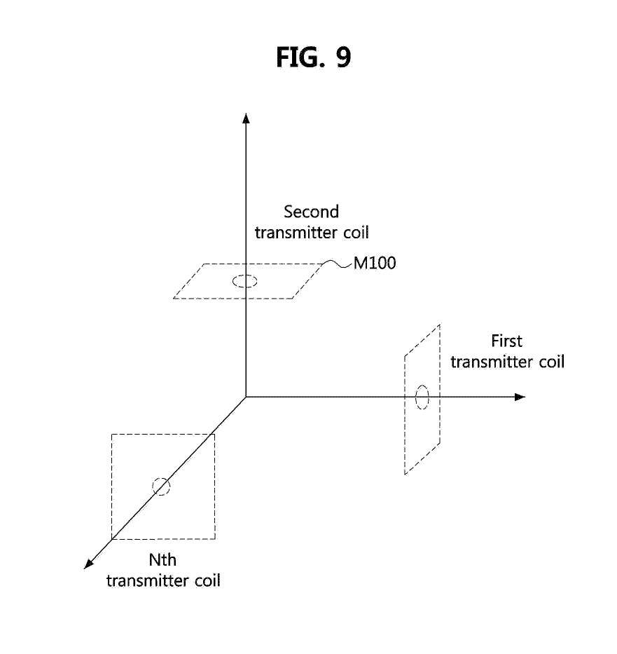

FIG. 8 is an exemplary view showing variance in phase and amplitude of a transmission signal according to one exemplary embodiment of the present invention. FIG. 9 is an exemplary view showing an increase in the number of axes as the number of transmitter coils increases.

As shown in FIGS. 8 and 9, when there are a phase axis and an amplitude axis, the number of cases for increasing or decreasing in phase and amplitude is represented as 9 cases including origin point of the phase and amplitude in which charging is started. This represents a case for each transmitter coil, and when the number of transmitter coils is two, the case may be represented to total 80 cases using a calculation like 9*9−1. When the number of transmitter coils on a transmitter pad is N, the number of cases is calculated by 9̂N−1. The number of axes and cases may increase with an increase in the transmitter coils. A degree of increasing or decreasing phase and amplitude may be set optionally, and the convergence rate may vary based on the amplitude.

In each case, transmission signals may be bundled and transmitted sequentially similar to a method of transmitting signals in QAM, and power transmission efficiency may be measured for each case. Further, amplitude and phase of the bundled transmission signals with the highest transmission efficiency may be selected. While the power transmission efficiency is measured by increasing or decreasing phase and amplitude of a transmission signal from respective transmitter coils, adjusting the phase and amplitude of the transmission signal may be performed by the controller repeatedly until no further increase in power transmission efficiency is measured. In other words, phase and amplitude of multiple transmission signals may be set to where the power transmission efficiency on the receiver pad 20 is a highest.

FIG. 10 is a flowchart for describing a method of controlling a wireless power transmission system according to another embodiment of the present invention.

The method of controlling the wireless power transmission system according to the present embodiment will be described below with reference to FIG. 10.

First, a controller (hereinafter, referred to as a first controller) of a wireless power transmission apparatus obtains a unique identifier (ID) and position information of a charging target vehicle entered into a service area of a charging station (S1001). The operation (S1001) may be implemented to transmit the ID and position information of the vehicle from a vehicle controller or a wireless power receiving apparatus to the first controller when the vehicle on which a receiving pad is mounted approaches a transmission pad.

The charging target may include an electronic device such as a cellular phone in addition to the vehicle. Also, the ID and position information of the charging target obtained by the first controller are obtained through the direct communication with the charging target, but are not limited thereto. For example, a license plate number of the vehicle may be recognized through a camera or a vision sensor connected to the first controller, and an image processing device and the unique ID corresponding to the license plate number of the vehicle may be obtained, or the position information of the vehicle may be obtained through a separate landmark or wireless access point which is pre-installed at a position at which the vehicle is located.

Next, the first controller determines whether previous data related to the wireless power transmission is present or not based on the ID of the charging target (S1003). Of course, the present operation may be performed on an external device (network management server or the like) according to a request of the first controller.

When it is determined that the previous data is present in Operation S1003, the first controller may match the phases of the transmission signals of the plurality of transmission coils to the phase and the size which are pre-stored in a storage unit or the like, and output the transmission signals from each transmission coil to the receiving pad of the charging target (S1005).

On the other hand, when it is determined that the previous data, that is, the pre-stored ID is not present in Operation S1003, the controller may synchronize the plurality of transmission signals, that is, may match the phases of the plurality of transmission signals (S1007), and output the plurality of transmission signals having the matched phase from the plurality of transmission coils to the receiving coil (S1009).

The output operation of the transmission signals (S1005 or S1007) may be implemented so that the plurality of transmission signals have the phase of 0 and the size of 50% or less of the rated output power according to the request of the wireless power receiving apparatus.

Next, a controller (hereinafter, referred to as a second controller) of the wireless power receiving apparatus may receive the transmission signals in the receiving coil and may measure power transmission efficiency of the received transmission signals (S1011). The second controller may collect power transmission parameters between the transmission coils and the receiving coil in order to extract the power transmission efficiency. The power transmission parameters may be collected from a sensor coupled to the transmission pad or the transmission circuit, or from the wireless power receiving apparatus or the vehicle controller coupled to the receiving pad. The power transmission parameters may include a waveform of a voltage or a current of the transmission signal or the receiving signal, or power information.

Next, the first controller may receive efficiency information or transmission coil operation control information corresponding thereto from the second controller, and control the sizes or phases of the transmission signals based on the efficiency information or the transmission coil operation control information (S1013). In order to adjust the sizes or phases of the transmission signals, the first controller may change the size or phase of each path of the transmission signals (S1013a) in the controlling of the sizes or phases of the transmission signals respectively S1013, measure power transmission efficiency of each transmission signal (S1013b), and may set the size or phase of the transmission signal representing maximum power transmission efficiency (S1013c) according to the power transmission efficiency.

Next, the first controller determines whether the current power transmission efficiency increases compared to the previous power transmission efficiency (S1015). When it is determined that the current power transmission efficiency does not increase compared to the previous power transmission efficiency, the subsequent operations may be repeatedly performed by being returned to the controlling of the size or phase of the transmission signal S1013. On the other hand, when it is determined that the current power transmission efficiency increases compared to the previous power transmission efficiency in Operation S1015, the first controller may determine whether the wireless power transmission is completed or not or the charging is completed or not (S1017). When it is determined that the charging is not completed in Operation S1017, the subsequent operations may be repeatedly performed by being returned to the controlling of the size or phase of the transmission signal S1013, and when it is determined that the charging is completed in Operation S1017, the current operation may end.

According to the present embodiment, when the wireless power receiving apparatus controls the wireless power transmission process of the wireless power transmission system, the pre-stored information corresponding to the ID or position information of the vehicle may be used for initial setting of the plurality of transmission signals, and thus, before the wireless power transmission process is started, wireless power transmission environment may be optimized based on the plurality of transmission signals output from the plurality of transmission coils.

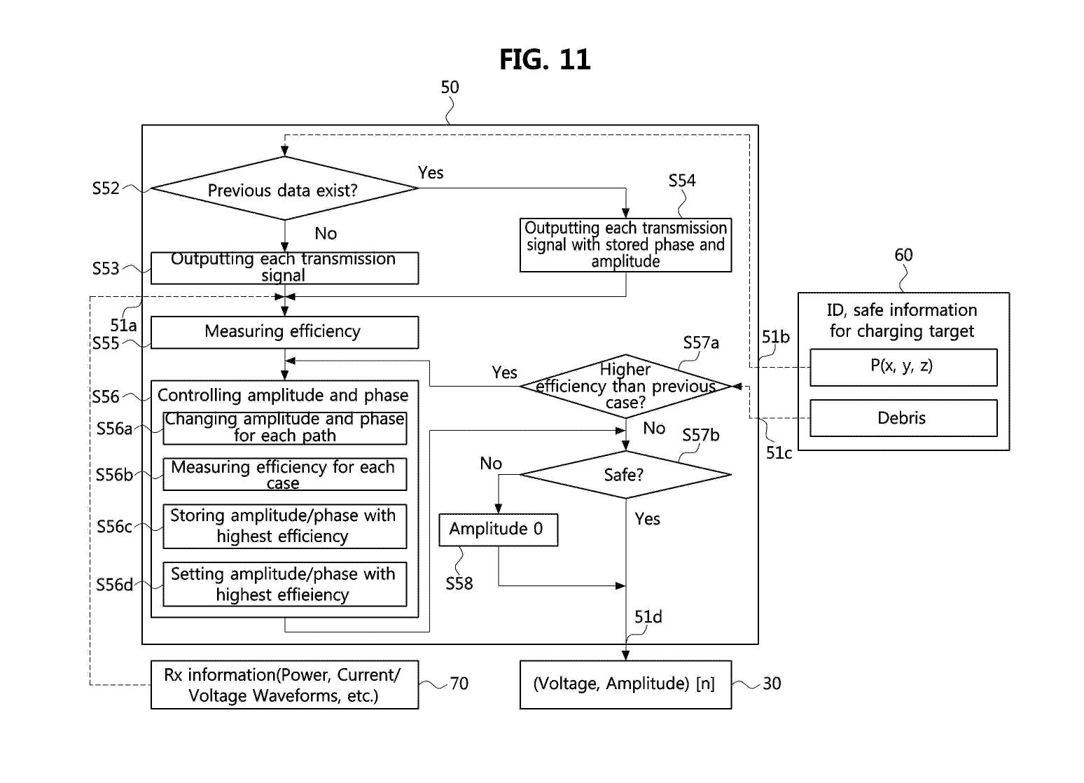

FIG. 11 is a block diagram illustrating a wireless power transmission system according to a further exemplary embodiment of the present invention.

Referring to FIG. 11, the wireless power transmission apparatus according to this embodiment may include a plurality of transmitting coils, transmission pad, the transmitting circuit array 30, the control unit 50, the information collecting unit 60 and a storage unit 70. The transmission coils, the transmission pads and the transmission circuit array 30 may substantially be identical to components of FIG. 1 to FIG. 1, but is not limited thereto.

The transmission circuit array 30 is connected to the transmission pad having a plurality of transmitting coils, and has a plurality of transmission circuits for supplying a transmission signal to each transmission coil thereof. The transmission circuit array 30 is provided with the plurality of transmission circuits on a single substrate, which may be connected to the transmitter coil, respectively. Each transmission circuit have a power supply circuit (charging power supply part) for wireless power transmission and/or a communication circuit for a local area network communication. Of course, the communication circuit can be connected is implemented in another communication unit control section 50.

The control unit 50 may include an input unit, an initial setting unit, a determining unit, an adjusting unit, a safety setting unit and an output unit. Hereinafter, the control unit of the wireless power transmission apparatus may correspond to a first control unit. Also, for convenience of explanation, although the control unit 50 is illustrated on the basis of main functions or operations of the input unit, the initial setting unit, the determining unit, the adjusting unit, the safety setting unit and the output unit, the present invention is not restricted thereto.

The input unit may include a first input unit 51a, a second input unit 51b, and a third input unit 51c. The first input unit 51a is connected to the storage unit 70 and it may be an input port or an input/output port through which information from the receiving coil or the receiving pad (Rx pad) is input. Further, the first input unit 51a may be connected to a second control unit of the wireless power receiving apparatus or the receiving pad. In this case, the first input unit 51a may include an analog-digital converter for detecting specific information or a control value from signals inputted from the second control unit or a vehicle controller via the communication units. The second input unit 51b may be connected to the information collection unit 60, and it may be other input port or input/output port of the first control unit through which identification information or position information P(x, y, z) of the charging target is input. The information inputted to the second input unit 51b is transferred to the initial setting unit. Furthermore, the third input unit 51c is connected to the information collection unit 60, and it may be still other input port or input/output port of the first control unit through which information of debris or foreign matters placed between the transmission pad and the receiving pad. The information inputted to the third input unit 51c may be transferred to the safety setting unit.

The initial setting unit may include a comparison unit, a first synchronization unit and a second synchronization unit to make phases or sizes of the transmission signals coincide with each other in a variety of ways. The comparison unit determines whether previous data exist (S52). When the previous data do not exist, the first synchronization unit may match the phases or the sizes of the transmission signals to the predetermined values (S53). Also, the second synchronization unit may make the phases and the sizes of the transmission signals coincide with each other for the charging target using recorded phases or sizes when they exist (S54).

The determining unit may include a collection unit and an efficiency measurement unit. The collection unit collects power transmission parameters between the transmission coils and a receiving coil under wireless power transmission. The collection unit may be integrated to the information collection unit 60. The efficiency measurement unit may measure power transmission efficiency based on the power transmission parameters (S55). In the other word, the efficiency measurement unit may determine power transmission efficiency based on voltage wave, current wave or power information of the transmission signals or the receiving signals.

The adjusting unit may include a size and phase controller for controlling the phase and the size of the transmission signals. The adjusting unit may include a first adjusting unit, a second adjusting unit, a third adjusting unit, and a fourth adjusting unit. The first adjusting unit may be implemented as a means which changes one of the phase and the size of the transmission signal on a signal path according to each transmission coil or a configuration unit (for example, a switch) which performs a function (S56a) corresponding to the means. The second adjusting unit may be implemented as a means which measures power transmission efficiency on the signal path or a configuration unit (for example, a multiplier) which performs a function (S56b) corresponding to the means. The third adjusting unit may be implemented as a means which sets the transmission signal with at least one of the phase and the size of maximum power transfer efficiency or a configuration unit (for example, a delay circuit, a scaler, etc.) which performs a function (S56c) corresponding to the means. Furthermore, the fourth adjusting unit may be implemented as a means which stores at least one of the phase and the size of each transmission signal or a configuration unit (for example, cash memory) which performs a function (S56d) corresponding to the means.

The safety setting unit may include a safety conditions determination unit and output cut-off unit. The safety conditions determination unit may be implemented as a means which judges whether wireless power transmission circumstance is safe based on detecting decrease in power transmission efficiency (S57a) according to the debris information of the information collection unit 60 or a configuration unit which performs a function (S57b) corresponding to the means.

The safety conditions determination unit may be implemented as a determining circuit whose state or level changes according to the detecting result of the third input unit 51c to which the debris information is inputted.

For example, when the debris information indicates that debris exists, the safety conditions determination unit may output the first control signal for setting the size of the transmission signal of the transmission coil to zero. This is to prevent output transmission of the adjusting unit from normally arriving at the transmission coil when the debris information indicates the presence of the debris or foreign matters (S58).

The first control signal may be used to set the size of the transmission signal to zero by controlling the operation of the output cut-off unit. The output cut-off unit may inactivate an output buffer or an amplifier.

Further, the output cut-off unit may output a second control signal for allowing the output of the adjusting unit to arrive at the transmission coil when the debris information indicates the absence of the debris or foreign matters. The second control signal may have a different level from a level of the first control signal. The different level may be a signal level by which the output cut-off unit is not operated.

The output unit 51d may be connected, as an output port or input/output port of the control unit 50, to the safety setting unit internally and to a specific transmission circuit externally. Also, the output unit 51d may be further connected to the transmission circuit array 30 having a plurality of transmission circuits for controlling the voltage and the phase of respective transmission signals on the plurality of the transmission coils (n).

The information collection unit 60 may be implemented as a means which transfers the information of vehicle identification from receiving devices (for example, vehicle controller, wireless charging control device, etc.) equipped with at least one of receiving coils for receiving the transmission signals to the control unit 50, or a configuration unit which performs a function corresponding to the means. The information collection unit 60 may be implemented as including a wireless communication unit or as a single entity having the functions of the wireless communication unit.

The storage unit 70 may be implemented a memory, etc. The memory may include a storage medium having the form of a volatile memory such as a random access memory (RAM) and a read-only memory (ROM) or a nonvolatile memory. Also, the storage unit 70 may include a storage medium such as a floppy disc, a hard disc, a magnetic tape, a compact disc (CD) ROM, and a flash memory in some example embodiments.

In the embodiment, the storage unit 70 may store power transmission parameters, information of the receiving pad, unique identification information of the charging target, setting values of the phase and the size in maximum power transmission efficiency, etc.

Furthermore, the storage unit 70 may be stored at least one of waveforms of the voltage and the current collected from each transmission coil or its transmission signal by sensors arranged among the plurality of the transmission coils and the transmission circuit array 30.

According to the embodiment, the apparatus of the present invention may start the process for optimizing operational circumstance of wireless power transmission by setting at least one of the initial phases and the initial sizes of the transmission signals to zero or about 50% based on information of unique identification and a position of vehicle, change the phases or the sizes, and obtain the specific phases and the specific sizes in maximum power transmission efficiency as shown in FIG. 8, thereby maximizing the efficiency in wireless power transmission using the plurality of the transmission coils.

Further, according to the embodiment, the obtained phases and amplitudes belong to the specific vehicle, and the height of the vehicle, position of the mounted receiver pad and receiver coil may be different based on the vehicle model. In addition, although vehicles belong to the same model, each vehicle may have a different impedance condition. Consequently, in the processing of wireless power transmission, the optimized power transmission data for a unique vehicle identification number may be recorded and stored for the next charging. When the phase and amplitude data is accumulated with the charging, the time required to maximize the power transmission efficiency may be decreased by analyzing the accumulated data.

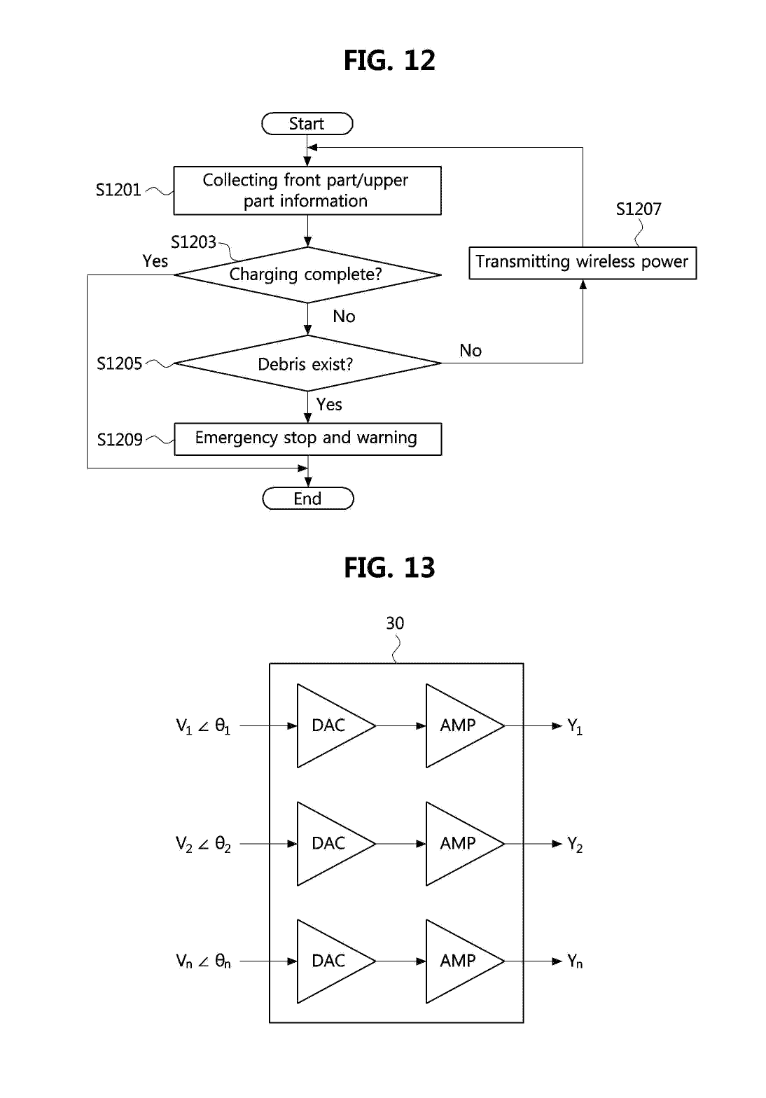

FIG. 12 is a partial flowchart for describing some operating processes of the wireless power transmission apparatus of FIG. 11.

The wireless power transmission apparatus according to the present embodiment may determine whether a foreign material is present or not in a wireless power transmission area in the optimization of the environment using the plurality of transmission signals before the wireless power transmission process is started according to the request of the wireless power receiving apparatus, the start of the wireless power transmission process may be delayed or stopped through the determination, and thus a safety problem due to the foreign material may be prevented in advance. To this end, the first controller of the wireless power transmission apparatus may monitor the environment of the vehicle using an imaging device provided in a front portion and/or an upper portion of the vehicle before the charging operation is performed using the transmission signals.

More specifically, as shown in FIG. 12, the first control unit collects information of the area of the power transmission of the vehicle or vehicle surroundings using capturing devices (e.g., imaging devices, sensors, or the like) (S1201). The first control unit may determine whether the wireless charging is processing (S1203), and determine whether debris exists when wireless charging is in progress (S1205).

Next, when debris such as a person or animal does not exist in the operation S1205, the first control unit may process the wireless power transmission (S1207). Here, the first control unit may repeatedly perform to collect information about the debris or foreign matter in at least one of a front part, a lower part and an upper part of the vehicle by cooperating with the information collection unit.

Meanwhile, when debris exist in the operation S1205, the first control unit may cut-off rapidly the wireless power transmission process and transfer an alarm message to the predetermined receiver (S1209).

According to this embodiment, using the capturing device allows for the possibility of detecting the presence of people, animals, or debris, and thus safety and reliability of wireless charging may be improved.

FIG. 13 is an exemplary view plan showing a configuration and input/output of a transmission circuit according to one exemplary embodiment of the present invention.

Referring to FIG. 13, a transmission circuit array 30 according to the present embodiment may have a converter (DAC) and an amplifier (AMP) that corresponds to each transmitter coil.

In the other word, a first transmission circuit of the transmission circuit array 30 may receive a first transmission signal having a first phase and a first size (V₁<θ₁), and transmit a first output signal Y₁ digital-analog modulated and amplified from the first transmission signal to a first transmission coil. A second transmission circuit of the transmission circuit array 30 may receive a second transmission signal having a second phase and a second size (V₂<θ₂), and transmit a second output signal Y₂ digital-analog modulated and amplified from the second transmission signal to a second transmission coil. A n-th transmission circuit of the transmission circuit array 30 may receive a n-th transmission signal having a n-th phase and a n-th size (Vₙ<θₙ), and transmit a n-th output signal Yₙ digital-analog modulated and amplified from the third transmission signal to a third transmission coil. Here, n is a natural number of 3 or more.

FIG. 14 is a schematic block diagram illustrating a wireless power receiving apparatus according to still another embodiment of the present invention.

Referring to FIG. 14, the wireless power receiving apparatus 200 (see FIG. 1) includes a receiving pad 20, a sensor 23, a controller 24, a storage 28, and a communication unit 29. The controller 24 of the wireless power receiving apparatus may be referred to as a second controller.

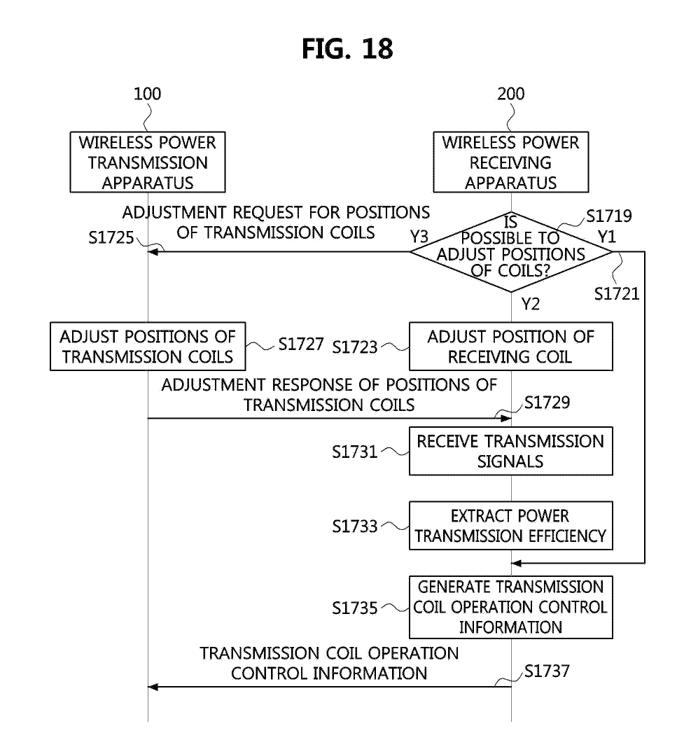

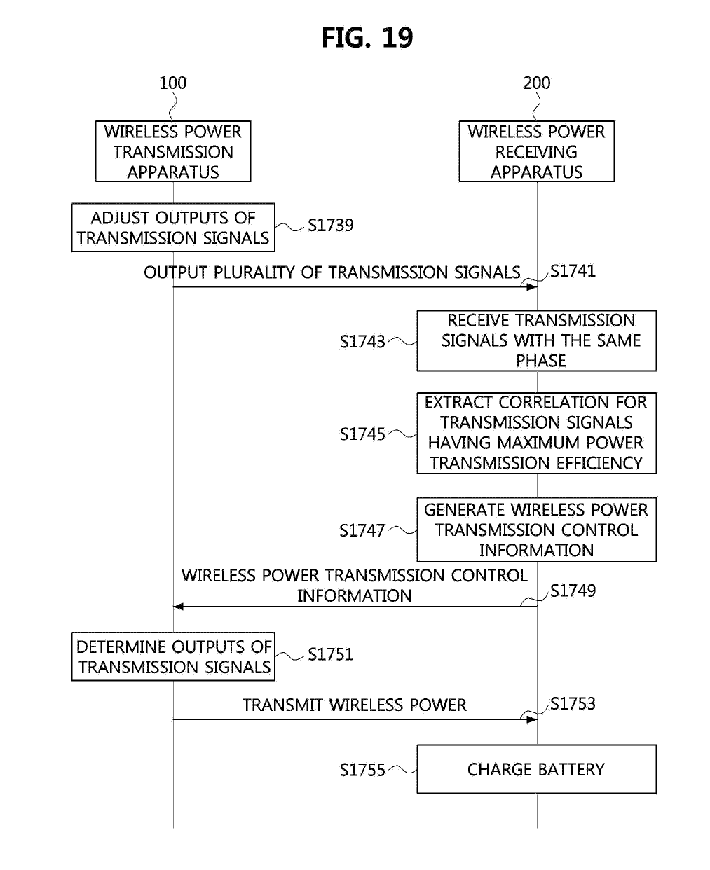

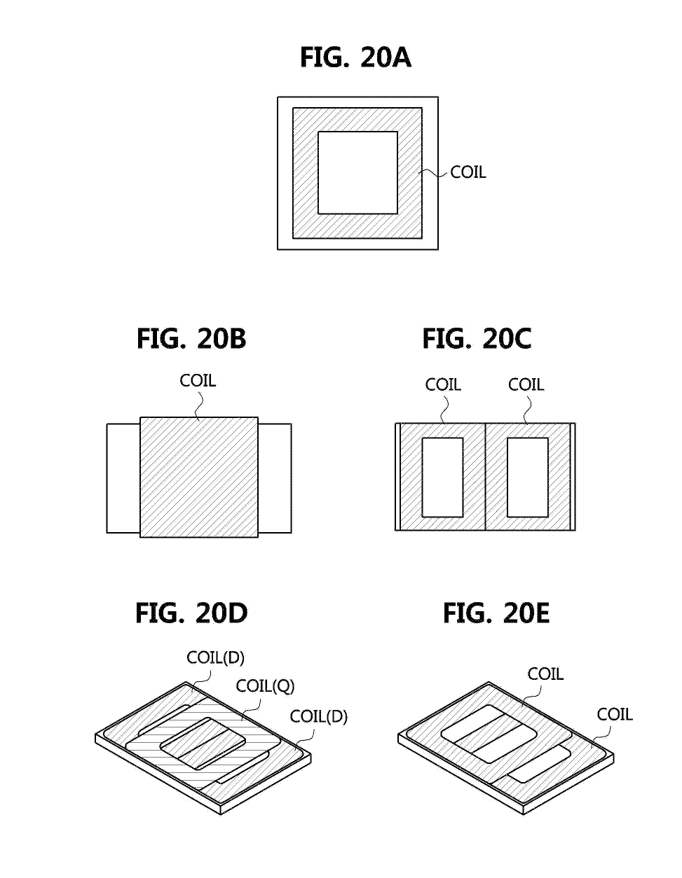

When each component is described in more detail, the receiving pad 20 may include the receiving coil 22 (see FIG. 1) and a support or an insulating material which supports the receiving coil. The receiving pad 20 may have various forms according to types or structures of the support or the insulating material, or an arrangement of the receiving coil (see FIG. 20).

The receiving coil may receive wireless power from the transmission coils using a magnetic induction method when the receiving coil and the transmission coils are disposed at an interval of a few centimeters, and wireless power from the transmission coils using a magnetic resonance method when the receiving coil and the transmission coils are disposed at an interval of several tens of centimeters to several meters. Here, a frequency used in the wireless power transmission may be selected from within a range of several tens of kHz to several tens of MHz such as 125 kHz, 13.56 MHz, etc. As the wireless charging method of the vehicle such as an electric vehicle or the like, the magnetic induction method and the magnetic resonance method may be used together or may be selectively used.

The sensor 23 may include a measuring means which is coupled to the receiving pad 20 or the receiving coil and measures at least one of a voltage or a current induced to the receiving coil by the plurality of transmission coils. The measuring means may include a voltmeter, an ammeter, etc. Further, the sensor 23 may further include a measuring means such as a wattmeter which outputs power information based on the measured voltage and/or the measured current, or the like.

The controller 24 may include at least one means which is connected to the receiving coil, detects electromotive force induced to the receiving coil by the plurality of transmission signals of the transmission coils, extracts the power transmission parameter from the detected electromotive force, and transmits the extracted power transmission parameter or related information (including derivatives) to the transmitting apparatus coupled to the transmission coils, or a configuration unit which performs a function corresponding to the means. In the present embodiment, the controller 24 includes a receiving unit 25, an extraction unit 26, and a transmission unit 27.

The receiving unit 25 may be implemented as a means which receives the plurality of transmission signals through the receiving coil or a configuration unit which performs a function corresponding to the means. The receiving unit 25 may sequentially receive the plurality of transmission signals in a predetermined order or by some of groups, may simultaneously receive all the plurality of transmission signals, or may repeatedly receive the transmission signals for a predetermined time or by a preset number of times.

The receiving unit 25 may include a measuring means such as the sensor 23 or the like, but is not limited thereto. The receiving unit 25 may include a circuit unit (first circuit unit) which is connected to the sensor 23 and detects intensity or a waveform of the voltage, intensity or a waveform of the current, or power or a waveform of the current from an output signal of the sensor 23. The receiving unit 25 may include a set of analog-to-digital converters provided in an input end of a processor.

The extraction unit 26 may be implemented as a means which extracts the power transmission parameter by the plurality of transmission signals or a configuration unit which performs a function corresponding to the means. The extraction unit 26 may extract the power transmission efficiency based on the power transmission parameter detected in the receiving unit 25. The power transmission parameter may include a voltage, a current, power, a voltage waveform, a current waveform, or a combination thereof. Further, the extraction unit 26 may extract correlation between the transmission signals based on a change of the power transmission efficiency by the transmission signals received multiple times.

The transmission unit 27 may be implemented as a means which transmits the transmission coil operation control information generated based on the power transmission parameter or the power transmission efficiency to the wireless power transmission apparatus, or a configuration unit which performs a function corresponding to the means. Further, the transmission unit 27 may transmit the correlation between the plurality of transmission signals generated in a process in which the receiving of the plurality of transmission signals and the extraction of the power transmission efficiency through the receiving unit 25 and the extraction unit 26 are repeated, or the wireless power transmission control information generated based on the correlation to the wireless power transmission apparatus.

In the present embodiment, the control portion 24, like a processor, may include one or more cores, a cache memory, a memory interface, and a peripheral interface. The peripheral interface may connect the control portion 24 with an input/output system and several other peripheral devices. The memory interface may connect the control portion 24 with the storage portion 28.

When the control portion 24 includes a multi-core structure, the control portion 24 may be formed by integrating two or more independent cores into one package formed of a single integrated circuit. Also, the control portion 24 may include a central processing unit (CPU). The CPU may be formed as a system on chip (SoC) in which a micro control unit (MCU) and a peripheral device that is an integrated circuit for an external expansion device are arranged together but is not limited thereto. Also, the control portion 24 may include a register which stores a command to be processed, an arithmetic logical unit (ALU) which performs comparison, determination, and calculation, an internal control unit which internally controls the core to analyze and execute the command, and an internal bus.

Also, the control portion 24 may include one or more data processors, image processors, or coder-decoders (CODEC) but is not limited thereto. The data processor, image processor, or CODEC may be an additional component connected to the control portion 24.

The control portion 24 described above may perform data input, data processing, data output to perform the secondary charging pad alignment method by executing several software programs. Also, the control portion 71 may operate a particular software module (an instruction set) stored in the storage portion 28 and may perform several particular functions corresponding to the corresponding module. That is, the control portion 24 may be provided to perform the method of controlling wireless power transmission system or to control wireless power receiving apparatus using software modules stored in the storage portion 28 and to perform wireless communication with a charger through the communication portion 29.

The storage portion 28 may be implemented as a memory or the like. The storage portion 28 may be substantially the same as the storage unit described above with reference to FIG. 11.

The communication portion 29 may include a communication interface. The communication interface supports at least one communication protocol so that the wireless power receiving apparatus is connected to the wireless power transmission apparatus, a server device, a file server, or other devices on a network through the network. The communication interface may include at least one wireless communication subsystem. The wireless communication subsystem may include a radio frequency receiver and transceiver, and/or an optical (e.g., infrared) receiver or transceiver.

A network accessible by the communication portion 29 describe above, for example, may include a global system for mobile communication (GSM), enhanced data GSM environment (EDGE), code division multiple access (CDMA), wideband CDMA (WCDMA), long term evolution (LTE), LTE-advanced (LTE-A), orthogonal frequency division multiple access (OFDMA), WiMAX, wireless fidelity (Wi-Fi), Bluetooth, etc.

FIG. 15 is a flowchart for describing a process of controlling a plurality of transmission signals of the wireless power transmission apparatus by the wireless power receiving apparatus of FIG. 14.

Referring to FIG. 15, the wireless power receiving apparatus 200 according to the present embodiment receives the plurality of transmission signals output from the wireless power transmission apparatus 100 (S1501). The wireless power receiving apparatus 200 may receive the plurality of transmission signals received using an electromagnetic induction method or a magnetic resonance method through the receiving unit coupled to the receiving coil, and extract the power transmission parameter by the plurality of transmission signals (S1503). The power transmission parameter may include a voltage, a current, or power as an inspection value. Further, the power transmission parameter may include a voltage waveform, a current waveform, or power information as a measured value for a predetermined time. The power information may include average power or maximum power.

The magnetic resonance method may be substantially the same as the electromagnetic induction method except that it is configured to increase energy transmission efficiency by matching a resonance frequency at an interval greater than few centimeters.

Next, the wireless power receiving apparatus 200 may extract the power transmission efficiency for the plurality of transmission signals based on the power transmission parameter (S1507). In the present embodiment, the power transmission efficiency may be referred to as efficiency (sum of power efficiency and combined efficiency) when a direct current signal of the transmitting apparatus is transmitted to the receiving apparatus with a high-frequency signal. In this case, the power efficiency of the power transmission efficiency may be extracted by measuring a voltage and a current of the direct current signal in the transmitting apparatus and a voltage and a current of a high frequency (RF) end in the receiving apparatus and calculating each power. Also, the combined efficiency may be measured using a vector network analyzer (VNA). That is, an S-parameter may be measured by connecting an input high frequency (RF) end of the transmitting apparatus to a first terminal of the VNA and an receiving high frequency (RF) end of the receiving apparatus to a second terminal of the VNA using the VNA. Input power, output power, and loss by the VNA may be extracted using the S-parameter. The combined efficiency in the VNA may be represented by a square (e.g., |S21|²) of an absolute value of a value obtained by dividing the input voltage of the first terminal by the output voltage of the second terminal.

Meanwhile, the power transmission efficiency according to the present embodiment is not limited to the above-described efficiency. In some implementations, the power transmission efficiency may be replaced by a combined efficiency when a high frequency signal of the transmitting apparatus is converted into a high frequency signal of the receiving apparatus, or efficiency including power efficiency when a direct current signal of the transmitting apparatus is converted into a high frequency signal and/or power efficiency when a high frequency signal of the receiving apparatus is converted into a direct current signal.

Next, the wireless power receiving apparatus 200 generates the transmission coil operation control information based on the power transmission parameter or the power transmission efficiency (S1509). The transmission coil operation control information may include information for how much a phase of at least any one of the transmission signals of the plurality of transmission signals is faster or slower according to the comparison of the power transmission parameter and the reference parameter. When the phase of the transmission signal is changed, the size of the transmission signal at a predetermined timepoint may also be changed. Further, in a modified embodiment, the transmission coil operation control information may be implemented to further include the size adjustment information for increasing or decreasing the size of the transmission signal in addition to the phase adjustment information for at least any one transmission signal.

Next, the wireless power receiving apparatus 200 transmits the transmission coil operation control information to the wireless power transmission apparatus 100 (S1511). The wireless power transmission apparatus 100 may adjust the outputs of the plurality of transmission signals in response to the transmission coil operation control information received from the wireless power receiving apparatus 200 (S1513). For example, the wireless power transmission apparatus 100 may adjust the phase of at least one of the plurality of transmission signals output from each of the plurality of transmission coils or the phase and the size thereof, and may adjust the output of each of the plurality of transmission signals so as to have the same phase or maximum power transmission efficiency in the receiving coil.

Meanwhile, in the present embodiment, the process of controlling the wireless power transmission system has been described focusing on the wireless power receiving apparatus 200, but the present invention is not limited thereto. The wireless power transmission apparatus 100 may be implemented to control the operation of the wireless power transmission system.

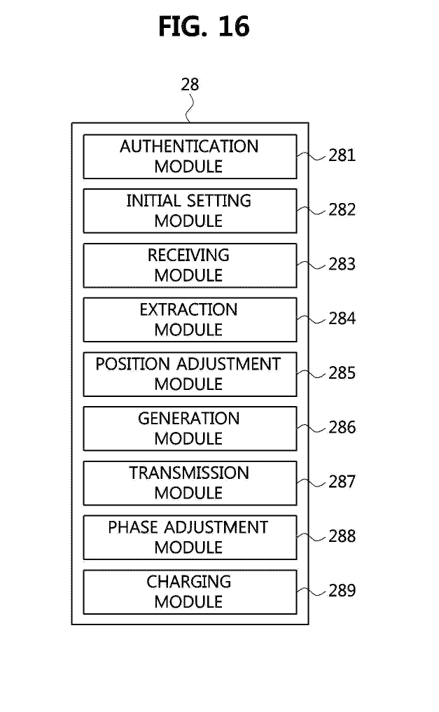

FIG. 16 is a partial block diagram illustrating a wireless power receiving apparatus according to still another embodiment of the present invention.

Referring to FIG. 16, the wireless power receiving apparatus according to the present embodiment may include a controller 24 (see FIG. 14) and a storage 28. Here, the storage 28 may include an authentication module 281, an initial setting module 282, a receiving module 283, an extraction module 284, a position adjustment module 285, a generation module 286, a transmission module 287, a phase adjustment module 288, and a charging module 289.

Here, the receiving module 283, the extraction module 284, and the transmission module 287, which are components corresponding to the receiving unit, the extraction unit, and the transmission unit in FIG. 14, may be implemented by performing the corresponding module stored in the storage unit by the controller. Similarly, the authentication module 281, the initial setting module 282, the position adjustment module 285, the generation module 286, the phase adjustment module 288, and the charging module 289 may be read from the storage 28 by the controller, and may correspond to the authentication unit, the initial setting unit, the position adjustment unit, the generation unit, the phase adjustment unit, and the charging unit which are performed in at least one of process or service form. A function or operation of each of the modules 281 to 289 in the storage 28 will be described in detail below in descriptions of the operation principle of the wireless power receiving apparatus.

Meanwhile, in the wireless power receiving apparatus according to the present embodiment, the storage 28 is described to include all the authentication module 281, the initial setting module 282, the receiving module 283, the extraction module 284, the position adjustment module 285, the generation module 286, the transmission module 287, the phase adjustment module 288, and the charging module 289, but is not limited thereto. The storage 28 may be implemented to include at least one of the other modules except for the receiving module 283, the extraction module 284, and the transmission module 287 among the above-described modules.

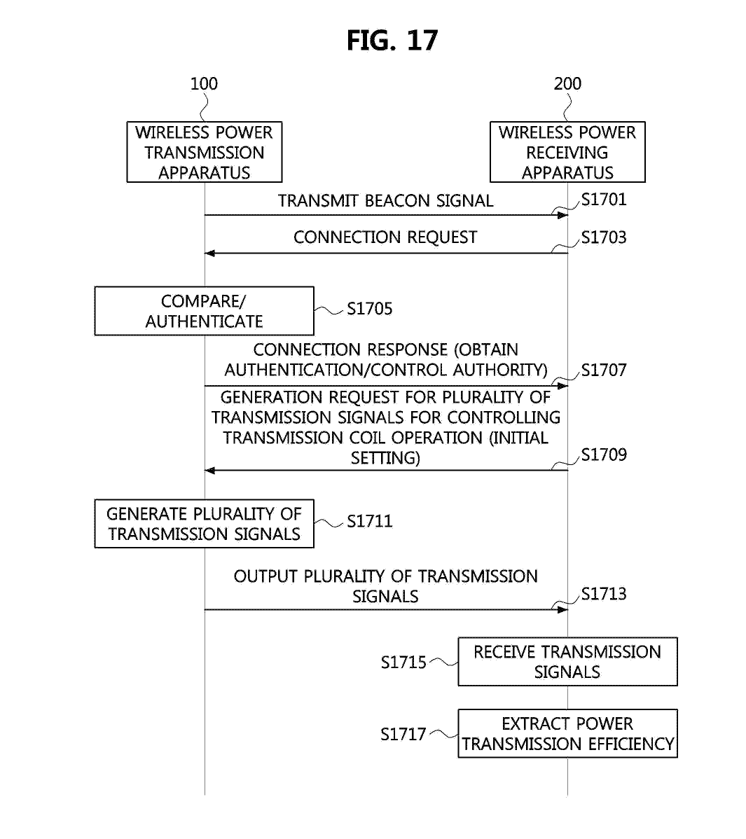

FIGS. 17 to 19 are flowcharts for describing a process of adjusting outputs of the plurality of transmission signals of the wireless power transmission apparatus by the wireless power receiving apparatus of FIG. 16.

First, referring to FIG. 17, the wireless power receiving apparatus 200 according to the present embodiment receives a beacon signal output from the wireless power transmission apparatus 100 (S1701). The beacon signal may include information on the charging station or the wireless power transmission apparatus, or an address of a destination (control server or the like) which provides information on the charging station or the wireless power transmission apparatus. When the beacon signal includes a connection address of the charging station or the wireless power transmission apparatus and the charging station or the wireless power transmission apparatus includes a means which may authenticate the wireless power receiving apparatus, the wireless power transmission apparatus may authenticate the wireless power receiving apparatus 200 through the comparison with the user information stored in the local storage unit or a cloud system on the network in response to the connection request (S1703) of the wireless power receiving apparatus 200 (S1705). The authenticated wireless power receiving apparatus 200 may obtain control authority for at least some operations of the wireless power transmission apparatus 100 within a preset range according to a connection response from the wireless power transmission apparatus 100 (S1707).

Of course, in some implementations, the authentication or the control authority of the wireless power receiving apparatus 200 for at least some operations of the wireless power transmission apparatus 100 may be omitted. For example, apparatuses (wireless power transmission apparatus and wireless power receiving apparatus) having a predetermined media access control (MAC) address may be set to freely communicate or collaborate through a predetermined channel. In this case, the authentication, the grant of the control authority, or the like may be omitted.

Next, when a communication channel is established with the wireless power transmission apparatus 100, the wireless power receiving apparatus 200 transmits a generation request signal of the plurality of transmission signals for controlling the transmission coil operation to the wireless power transmission apparatus 100 (S1709). The transmission signal generation request signal may include information for initially setting the plurality of transmission signals output from the plurality of transmission coils of the wireless power transmission apparatus 100. The information for initially setting may include control information which outputs the plurality of transmission signals to have the size of 50% or less of rated output power of the plurality of transmission signals. Here, the size of 50% or less of rated output power may include signal intensity corresponding to the size of 1/100 times or 1/10,000 times of the rated output power. Further, the information for initially setting may include control information for adjusting the phases of the plurality of transmission signals to the same phase. The same phase may include the phase of 0 based on a predetermined timepoint.

When the wireless power transmission apparatus 100 generates the plurality of transmission signals (S1711) to output to the receiving coil through the plurality of transmission coils (S1713) in response to the transmission signal generation request signal, the wireless power receiving apparatus 200 receives the transmission signals (S1715). The present operation may include detecting the power transmission parameter by the transmission signals.

Next, the wireless power receiving apparatus 200 may extract the power transmission efficiency based on the power transmission parameter (S1717).

Next, as illustrated in FIG. 18, the wireless power receiving apparatus 200 may determine whether positions of the transmission coils or a position of the receiving coil can be partially adjusted or not based on the power transmission parameter or the power transmission efficiency (S1719). As the present operation is a result in which the power transmission parameter or the power transmission efficiency is compared to a reference value or a current waveform, a voltage waveform, or a current/voltage pattern is compared to a reference waveform or a reference pattern, whether the adjustment of the positions of the coils is required or not, or the adjustment of the positions thereof is possible or not may be determined.

When it is determined that the adjustment of the positions of the coils is not required or the adjustment of the positions of the coils is impossible in Operation S1719 (Y1), it may be proceeded to an operation of generating transmission coil operation control information (S1721).

Meanwhile, when it is determined that the adjustment of the position of the receiving coil is possible in Operation S1719 (Y2), the position of the receiving coil may be adjusted based on a position adjustment value obtained from the power transmission parameter or the power transmission efficiency (S1723).

On the other hand, when it is determined that the adjustment of the positions of the plurality of transmission coils is possible in Operation S1719 (Y3), a signal for adjusting the positions of the plurality of transmission coils is generated based on the position adjustment value obtained from the power transmission parameter or the power transmission efficiency to transmit the generated position adjustment request signal to the wireless power transmission apparatus 100 (S1725). In this case, the wireless power transmission apparatus 100 may adjust the positions of the plurality of transmission coils according to the position adjustment request signal (S1727). The positions of the plurality of transmission coils may be individually adjusted or may be adjusted in a group, but are not limited thereto. When the plurality of transmission coils are arranged on a single transmission pad, it may be implemented to adjust the positions of the plurality of transmission coils by adjusting the position of the transmission pad. The position adjustment of the transmission pad or the position adjustment of the plurality of transmission coils may be performed by a driving device coupled to the transmission pad or the transmission coil using a predetermined method. The driving device, which is a device which gives physical movement to a control target based on the signal of the controller, may include an electric motor or an actuator. When the position adjustment of the plurality of transmission coils is completed, the wireless power transmission apparatus 100 may transmit a response signal for the position adjustment of the transmission coils to the wireless power receiving apparatus 200 (S1729).

On the other hand, when it is determined that the adjustment of the position of the receiving coil is possible and the adjustment of the positions of the plurality of transmission coils is possible in Operation S1719 (Y2+Y3), the wireless power receiving apparatus 200 may perform the adjustment of the position of the receiving coil (S1723) and the adjustment of the positions of the plurality of transmission coils (S1725, S1727, and S1731) together.

After the second selection (Y2), the third selection (Y3), or the fourth selection (Y2+Y3) are performed in Operation S1719, the wireless power receiving apparatus 200 may receive again the plurality of transmission signals according to the position adjustment of the wireless power transmission coils (S1731). Also, the power transmission efficiency may be extracted again based on the power transmission parameter obtained when receiving the plurality of transmission signals (S1733).

Next, the wireless power receiving apparatus 200 may generate transmission coil operation control information (S1735) and transmit the generated transmission coil operation control information to the wireless power transmission apparatus 100 (S1737). The transmission coil operation control information may be generated based on a set of the power transmission parameter or the power transmission efficiency, and used to adjust the output of each of the plurality of transmission signals.

Next, as illustrated in FIG. 19, the wireless power transmission apparatus 100 which receives the transmission coil operation control information from the wireless power receiving apparatus 200 may individually or entirely adjust the outputs of the plurality of transmission signals according to the transmission coil operation control information (S1739). Also, the wireless power transmission apparatus 100 may output the plurality of transmission signals, of which the phases are adjusted or the phases and the sizes are adjusted, to the receiving coil through the plurality of transmission coils (S1741).

Next, the wireless power receiving apparatus 200 may receive the plurality of transmission signals having the same phase (S1743). The present operation may include detecting the power transmission parameter from the plurality of transmission signals received with the same phase. The reception of the plurality of transmission signals from the receiving coil with the same phase may be achieved by the adjustment of the outputs of the plurality of transmitting coils in the previous operation. In the wireless power transmission, when the plurality of transmission signals output from the plurality of transmission coils are transmitted as the signals having the same phase in the receiving coil, the plurality of received transmission signals may become the signals having maximum power transmission efficiency.

Meanwhile, all the phases of the plurality of transmission signals having the maximum power transmission efficiency may not be the same according to an arrangement or structure of the plurality of transmission coils. Therefore, Operation S1743 may be selectively added to or omitted from the present embodiment.

Next, the wireless power receiving apparatus 200 may extract the power transmission efficiency for the plurality of transmission signals. Also, the wireless power receiving apparatus 200 may extract correlation between the plurality of transmission signals having the maximum power transmission efficiency by comparing the extracted power transmission efficiency (S1745). Of course, in the extracting of the correlation, the maximum power transmission efficiency may have a maximum value when the plurality of transmission signals having the same phase are received in the receiving coil.

Next, the wireless power receiving apparatus 200 may generate wireless power transmission control information based on the correlation (S1747), and transmit the generated wireless power transmission control information to the wireless power transmission apparatus 100 (S1749). The wireless power transmission apparatus 100 may determine the output of each of the plurality of transmission signals in response to the received wireless power transmission control information (S1751). The determination of the output of each of the plurality of transmission signals may include adjusting the phase of each of the plurality of transmission signals so that the transmission signals having the same phase are received in the receiving coil, or the transmission signals having the maximum power transmission efficiency are received in the receiving coil. When the phase of the transmission signal is determined, the size of the corresponding transmission signal may be changed according to the phase. Further, in some implementations, the determination of the output of each of the plurality of transmission signals may include adjusting the phase and size of each of the plurality of transmission signals. In this case, the wireless power transmission apparatus 100 may include additionally adjusting the size of the transmission signal separate from the phase adjustment according to the correlation.

When the adjustment of the output of each of the plurality of transmission signals is completed, the wireless power transmission apparatus 100 may transmit wireless power of rated output power to the receiving coil through the plurality of transmission coils which output the plurality of transmission signals in which the output adjustment is completed (S1753). The wireless power receiving apparatus 200 may receive the wireless power in which the power transmission efficiency is optimized to charge to the battery (S1755).

Meanwhile, in the present embodiment, the process of adjusting the outputs of the plurality of transmission signals of the wireless power transmission apparatus has been described focusing on the wireless power receiving apparatus 200, but the present invention is not limited thereto. The wireless power transmission apparatus 100 may be implemented to control the operation of the wireless power transmission system through the collaboration with the wireless power receiving apparatus 200.

FIGS. 20A-20E are diagrams illustrating an example of a pad structure that may be applied to the transmission pad or the receiving pad of the wireless power transmission system according to the present embodiment.

Referring to FIGS. 20A-20E, the transmission pad according to the present embodiment or a primary charger pad, or a receiving pad mounted an electric vehicle or a secondary inductive pad may include a pad structure according to a common pad topologies.

That is, the transmission pad or the receiving pad may include a structure in which the pads are disposed on an insulator in a circular shape or a rectangular shape without poles as illustrated in FIG. 20A, a solenoid polarized structure in which the pads surround a base material as illustrated in FIG. 20B, a double-D (DD) polarized structure as illustrated in FIG. 20C, a multi-coil double-D quadrature (DDQ) structure as illustrated in FIG. 20D, and a multi-coil bipolar structure as illustrated in FIG. 20E.

Inductive couplers such as the above-described primary and secondary charging pads may be designed by various topologies, induced by magnetics, and may have magnetic interoperability according to multi-coil topologies including any one of polarized and non-polarized structures or both thereof.

According to the present embodiment, the plurality of transmission coils of the transmission pad may have an array form or a grid form 12 to 18 (see FIG. 1), any one of the plurality of transmission coils may have in a circular shape or a rectangular shape without poles or a solenoid polarized structure in which the pads surround a base material, and any one or some of the plurality of transmission coils may have a DD polarized structure, a multi-coil DDQ structure, or a multi-coil bipolar structure. Also, the plurality of transmission coils may have an overlap structure or a stacked structure including at least one transmission coil disposed on an upper layer and at least one transmission coil disposed on a lower layer so that at least some areas which overlaps or does not overlap the upper layer, as similar to the multi-coil DDQ structure or the multi-coil bipolar structure. However, even when the plurality of transmission coils of the present embodiment have the above-described structure, the plurality of transmission coils may have a structure in which each of the transmission coils is independently connected to the transmission circuit, and thus may be controlled so that the outputs of the plurality of transmission signals are set to the size of 50% or less of rated output power, or the phase of at least one of the plurality of transmission signals or the phase and size thereof are adjusted according to the control of the wireless power receiving apparatus when the wireless power transmission operation is started.

In the method or apparatus according to the embodiments described above, at least some components thereof may be function units loaded in a computing apparatus including a control unit or a controller but are not limited thereto. The components described above may be embodied to be stored as a program or software for performing the method of controlling wireless power transmission system or the method of transmitting wireless power in a computer readable recording medium or a carrier to be transmitted from a remote place to be performed.

The computer readable recording medium may be embodied as one of a program instruction, a data file, a data structure, etc. and a combination thereof. A program written in the computer readable recording medium may be particularly designed for the present invention or may be available one publicly known to one of ordinary skill in the art.

Also, the computer readable recording medium may be included in a hardware apparatus particularly configured to store and execute program instructions such as an ROM, an RAM, a flash memory, etc. The program instructions may include not only machine language codes compiled by a compiler but also high-level language codes executable by a computer using an interpreter. The hardware apparatus may be configured to be operated as one or more software modules to perform the method according to the embodiments described above and the reverse thereof may be same.

When the method of controlling the wireless power transmission system, the wireless power receiving apparatus, and the method of transmitting wireless power according to the above-described embodiments of the present invention are used, it is possible to perform wireless power transmission suitable for a receiving coil by controlling a plurality of transmission signals of a transmission apparatus in a receiving apparatus of the wireless power transmission system.

Further, according to the present invention, at the beginning of the wireless power transmission process, environment for wireless power transmission is controlled according to relative positions of the plurality of transmission coils and the receiving coil, states of the plurality of transmission coils, or the like by monitoring a power transmission parameter by transmission signals output from the plurality of transmission coils of the receiving apparatus. Thus, the wireless power transmission can be effectively performed with maximum power transmission efficiency.

Further, according to the present invention, identification information on a vehicle or a receiving pad pre-stored in relation to wireless power transmission setting is used in the wireless power transmission system. Thus, the initial setting of the plurality of transmission signals can be effectively performed on the wireless power receiving apparatus.

Further, according to the present invention, at the beginning of the wireless charging operation, a foreign material that may present between the plurality of transmission coils and the receiving coil while the wireless power receiving apparatus determines a plurality of transmission signals of the wireless power transmission apparatus is detected in the wireless power transmission system. Thus, a safety problem that may occur during the wireless power transmission process can be prevented in advance, and thus, stability of the wireless power transmission system can be improved.

Further, according to a method of controlling a wireless power transmission system according to an embodiment of the present invention, transmission signals output from a plurality of transmission apparatuses are synchronized. Thus, a size and phase of each transmission signal can be easily controlled. Further, a size and phase of each of the plurality of transmission signals are corrected, and thus, power transmission efficiency can be improved. In addition, a safety problem that may occur during the wireless power transmission can be improved through foreign material detection.

While the example embodiments of the present invention and their advantages have been described in detail, it should be understood that various changes, substitutions and alterations may be made herein without departing from the scope of the invention.

What is claimed is:

1. A method of controlling a wireless power transmission system, which is performed on a wireless power receiving apparatus in a vehicle, comprising:
receiving a plurality of transmission signals output from a plurality of transmission coils connected to a wireless power transmission apparatus in a charging station, in a receiving coil mounted on the vehicle;
extracting power transmission efficiency for the plurality of transmission signals based on a power transmission parameter by the plurality of transmission signals; and
transmitting transmission coil operation control information based on the power transmission parameter or the power transmission efficiency to the wireless power transmission apparatus.

2. The method of claim 1, further comprising, before the receiving of the plurality of transmission signals, obtaining control authority for at least some operations of the wireless power transmission apparatus.

3. The method of claim 1, further comprising, before the extracting of the power transmission efficiency, transmitting a signal for adjusting a position of the receiving coil and at least any one of positions of the plurality of transmission coils to the wireless power transmission apparatus.

4. The method of claim 1, further comprising, before the receiving of the plurality of transmission signals, transmitting a signal for controlling outputs of the plurality of transmission signals to the size of 50% or less of rated output power in the plurality of transmission coils to the wireless power transmission apparatus.

5. The method of claim 4, wherein the transmitting of the transmission coil operation control information comprises changing a phase of a transmission signal of at least any one of the plurality of transmission coils through the transmission coil operation control information.

6. The method of claim 5, further comprising, after the transmitting of the transmission coil operation control information, receiving the plurality of transmission signals with the same phase.

7. The method of claim 5, further comprising:
after the transmitting of the transmission coil operation control information,
extracting correlation between the plurality of transmission signals representing maximum power transmission efficiency based on a change of the power transmission efficiency; and
transmitting wireless power transmission control information based on the correlation to the wireless power transmission apparatus.

8. A wireless power receiving apparatus comprising:
a receiving unit configured to receive a plurality of transmission signals output from a plurality of transmission coils connected to a wireless power transmission apparatus in a charging station, in a receiving coil;
an extraction unit configured to extract power transmission efficiency for the plurality of transmission signals based on a power transmission parameter by the plurality of transmission signals; and
a transmission unit configured to transmit transmission coil operation control information based on the power transmission parameter or the power transmission efficiency to the wireless power transmission apparatus.

9. The apparatus of claim 8, further comprising an authentication unit configured to obtain control authority for at least some operations of the wireless power transmission apparatus.

10. The apparatus of claim 8, further comprising a position adjustment unit configured to transmit a signal for adjusting a position of the receiving coil and at least any one of positions of the plurality of transmission coils according to the power transmission parameter or the power transmission efficiency to the wireless power transmission apparatus.

11. The apparatus of claim 8, further comprising an initial setting unit configured to transmit a signal for controlling outputs of the plurality of transmission signals to the size of 50% or less of rated output power in the plurality of transmission coils to the wireless power transmission apparatus.

12. The apparatus of claim 11, further comprising a phase adjustment unit configured to change a phase of a transmission signal of at least any one of the plurality of transmission coils through the transmission coil operation control information.

13. The apparatus of claim 12, wherein the receiving unit receives the plurality of transmission signals with the same phase.

14. The apparatus of claim 13, wherein:
the extraction unit extracts correlation between the plurality of transmission signals having maximum power transmission efficiency based on the plurality of transmission signals with the same phase or a change of the power transmission efficiency; and
the transmission unit transmits wireless power transmission control information based on the correlation to the wireless power transmission apparatus.

15. The apparatus of claim 14, further comprising a charging unit configured to receive wireless power according to the wireless power transmission control information and charge a battery.

16. A method of transmitting wireless power, comprising:
outputting a plurality of transmission signals from a plurality of transmission coils;
receiving transmission coil operation control information including a power transmission parameter by the plurality of transmission signals received in a receiving coil or power transmission efficiency corresponding to the power transmission parameter in a vehicle, from a wireless power receiving apparatus in the vehicle; and
adjusting outputs of the plurality of transmission signals based on the transmission coil operation control information.

17. The method of claim 16, further comprising, before the outputting of the plurality of transmission signals, generating the plurality of transmission signals having the size of 50% or less of rated output power in the plurality of transmission coils according to a transmission signal output request received from the wireless power receiving apparatus.

18. The method of claim 17, further comprising:
before the receiving of the transmission coil operation control information,
receiving a position adjustment request signal for adjusting positions of the plurality of transmission coils or a position of a transmission pad including the plurality of transmission coils based on the power transmission parameter or the power transmission efficiency; and
adjusting the positions of the plurality of transmission coils or the position of the transmission pad in response to the position adjustment request signal.

19. The method of claim 18, further comprising adjusting an output or phase of at least one of the transmission signals according to the transmission coil operation control information and outputting the plurality of transmission signals of which the output or the phase is adjusted.

20. The method of claim 19, further comprising:
receiving wireless power transmission control information based on correlation between the plurality of transmission signals from the wireless power receiving apparatus; and
determining the outputs of the plurality of transmission signals according to the wireless power transmission control information and transmitting wireless power to the receiving coil.
